(19) United States
(12) Patent Application Publication
(10) Pub. No.: US 2013/0085817 A1
(43) Pub. Date: Apr. 4, 2013

(54) DISCOUNT OFFER SYSTEM AND METHOD FOR USE WITH FOR HIRE VEHICLES

(71) Applicant: Michael Collins Pinkus, Alpharetta, GA (US)

(72) Inventor: Michael Collins Pinkus, Alpharetta, GA (US)

(21) Appl. No.: 13/249,027

(22) Filed: Sep. 29, 2011

(51) Int. Cl. G06Q 30/02

(52) U.S. Cl. 705/14.1; 705/14.4; 705/14.73; 705/14.49; 705/14.58

(57) ABSTRACT

A deal manager receives promotional offers from vendors. The deal manager publishes the deals to deal presenters. The deal presenters collect acceptance and payment information which is then sent back to the deal manager. The deal manager processes the payment information and sends a for-hire vehicle request to a reservation and dispatch system. A for-hire vehicle (for example, a taxi, shuttle or limo) is dispatched, or in another embodiment, the destination of a for-hire vehicle is modified so that a passenger may be transported to a location where the deal may be redeemed. The deal manger transmits a voucher containing a unique voucher code to the deal presenter. Vendors and drivers of for-hire vehicles validate the voucher using the unique voucher code.

### BACKGROUND

The present disclosure relates to the field of for-hire vehicles such as taxis, limousines, shuttles, buses or any other vehicle that provides shared transportation or transports one or more passengers between locations of the passengers' choice. The present disclosure also relates to the field of advertising.

A for-hire vehicle (FHV) generally charges fares for transporting a passenger from one location to another. Some FHVs, such as taxicabs, operate with a meter, while others such as limos and shuttles transport passengers for a pre-trip negotiated rate. FHVs are common in tourist destinations, business traveler destinations (for example, where convention centers are prevalent) or in densely populated urban areas where vehicle ownership is uncommon or impractical. Areas of high FHV use often offer numerous entertainment options. The entertainment options may include, among other things, shows, plays, concerts, dining, sporting events, or other special events. Travelers, business people and urban dwellers may frequent these entertainment options through the use of a FHV. For example, a business person in town for a convention may wish to dine at a restaurant and may hail a taxi to transport him to the restaurant.

Many entertainment options are time, location and quantity sensitive; the entertainment options offer a service that is available for a fixed time, at a specific location and only for a fixed number of people. For example, a play may start at 8 PM (fixed time), be performed at the Downtown Theater (specific location) and have 200 seats available (fixed number of people). In some cases, the number of tickets sold for the event is less than the seats available. For example, only 150 tickets may have been sold for the play in the 200 seat venue. As the 8 PM start time approaches, it may become clear to the vendor operating the play at the venue that the remaining 50 seats will not be sold. Once the play starts, any empty seat in the venue is a lost revenue opportunity. Restaurant owners face a similar lost revenue opportunity, even though the restaurant option may not have strictly fixed time. Empty tables at a restaurant, when there is adequate staff to serve the tables, is also a lost revenue opportunity.

### BRIEF DESCRIPTION OF THE DRAWINGS

FIG. 1 shows one illustrative embodiment of a deal presenter computing system in operation within for-hire vehicle.

FIG. 2 shows an embodiment of a deal presenter computing system affixed to the roof of for-hire vehicle and in communication with a consumer computing device.

FIG. 3A is a block diagram illustrative of one embodiment of a deal manager computing system in communication over a network with a deal presenter computing system, a vendor computing system, a payment processor computing system, a reservation and dispatch computing system and a for-hire vehicle which may comprise one or more computing systems controlling its operation.

FIG. 3B is a block diagram illustrative of one embodiment of a deal manager computing system in communication over a network with a deal presenter computing system, a vendor computing system, a payment processor computing system, and a for-hire vehicle which may comprise one or more computing systems controlling its operation. The deal manager computing system of FIG. 3B comprises a reservation and dispatch module.

FIG. 4 is a flowchart illustrating a high level view of the lifecycle of a deal.

FIG. 5 is a block diagram illustrating the temporal flow of data for the lifecycle of a deal through deal definition through deal confirmation between a deal presenter computing system, a vendor computing system, a payment processor computing system, a reservation and dispatch computing system and a for-hire vehicle which may comprise one or more computing systems controlling its operation.

FIG. 6 is an illustrative screenshot showing one embodiment of a vendor registration user interface.

FIG. 7 is an illustrative screenshot showing one embodiment of an offer detail user interface.

FIG. 8 is an illustrative screenshot showing one embodiment of a media upload user interface.

FIG. 9 is an illustrative screenshot showing one embodiment of a geographic restriction user interface.

FIG. 10 is an illustrative screenshot showing one embodiment of a user interface for updating a predefined deal using a mobile application.

FIG. 11 is an illustrative screenshot showing one embodiment of a deal being displayed on a deal presenter computing system.

FIG. 12 is an illustrative screenshot showing one embodiment of a user interface for selecting a category of deals thereby allowing a consumer or passenger to filter deals based on category.

FIG. 13 is an illustrative screenshot showing available deals in a selectable list view.

FIG. 14 is an illustrative screenshot showing one embodiment of an age verification user interface.

FIG. 15 is an illustrative screenshot showing one embodiment of a payment information user interface.

FIG. 16 is an illustrative screenshot showing one embodiment of a deal confirmation user interface.

FIG. 17 is an illustrative screenshot showing one embodiment of a deal being displayed on a deal presenter computing system that is a mobile device.

FIG. 18 is an illustrative screenshot showing one embodiment of a deal validation user interface.

FIG. 19 is a flow chart depicting the process flow of one embodiment of a deal manager computing system.

FIG. 20 is a flow chart depicting the process flow for one embodiment of a deal presenter computing system.

FIG. 21 is a flow chart depicting one illustrative example of decision process for displaying a deal.

### DESCRIPTION OF EMBODIMENTS

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

### Overview

In order for vendors offering entertainment options to maximize their revenue opportunity when dealing with a time, location and quantity sensitive asset, an opportunity arises to advertise, for a short period of time, the entertainment option at a discount. Furthermore, passengers of FHVs are a good target demographic for vendors; passengers are often travelers from out of town and may be looking for interesting and inexpensive entertainment options. The present disclosure recognizes this opportunity and that it is advantageous for vendors to offer discounted rates for their entertainment options to passengers of FHVs as they may be likely to purchase the offer at the discounted rate. Further, additional value may advantageously be added by including the fare to the venue in the discounted rate.

Accordingly, embodiments of the present disclosure describe systems and methods for integrating product and service discounting with requests for the reservation and dispatch of for-hire vehicles. In one embodiment, a deal manager computer system (or “deal manager”) manages deals offered by vendors and receives promotional offer (or “deal”) data from a vendor computer system. The vendor computer system may advantageously permit the entry of the promotional offer data though the use of a web page or other user interface. Based on the received promotional offer information, the deal manager computer system generates a deal, or offer, which is then communicated to a deal presenter computer system that displays the deal. Once a consumer purchases the deal, the deal manager computer system receives an notification of acceptance of the deal, or promotional offer. The acceptance includes location data and payment data. The deal manager uses the location data to reserve and dispatch a for-hire vehicle to pick up the person who accepted the deal, or to modify the trip information for a current passenger of a for-hire vehicle. The deal manager computer system uses the payment information to process payment for the deal. In addition, the deal manager computer system may also communicate a confirmation message to the deal presenter computer system and may communicate a confirmation message to the vendor computer system. The confirmation message to the deal presentation computer system may include a voucher number, code, or scanable image that may be used to validate the deal with the vendor and the driver of the dispatched for-hire vehicle, if necessary. The confirmation message may also include pick-up location information informing the consumer as to where a for-hire vehicle may pick them up. Once the consumer arrives at the venue of the vendor who offered the deal, the vendor may validate the purchased deal

In another embodiment, a deal presenter computer system is installed in a for-hire vehicle. The deal presenter computer system comprises a display that is affixed to the for-hire vehicle and a point-of-sale terminal for accepting payment instruments such as credit cards. The deal presenter computer system receives promotional offers (or “deals”) from a deal manager computer system that manages deals for one or more vendors. The received deals are shown on the display. A consumer (or “user”) may select one or more of the received deals and the deal presenter computer system may accept input indicating an acceptance of the deal. The deal presenter computer system may also accept payment information through the point-of-sale terminal. The promotional offer computer system may then transmit the acceptance and payment information to the deal manager computer system. The deal manager computer system may then process the received payment information and process a notification for the for-hire vehicle. The notification may contain location information associated with the vendor so that the for-hire vehicle computer system (or “trip computer”) may update the trip information associated with the passenger's current trip and route the for-hire-vehicle to the vendor location.

### Examples of Embodiments

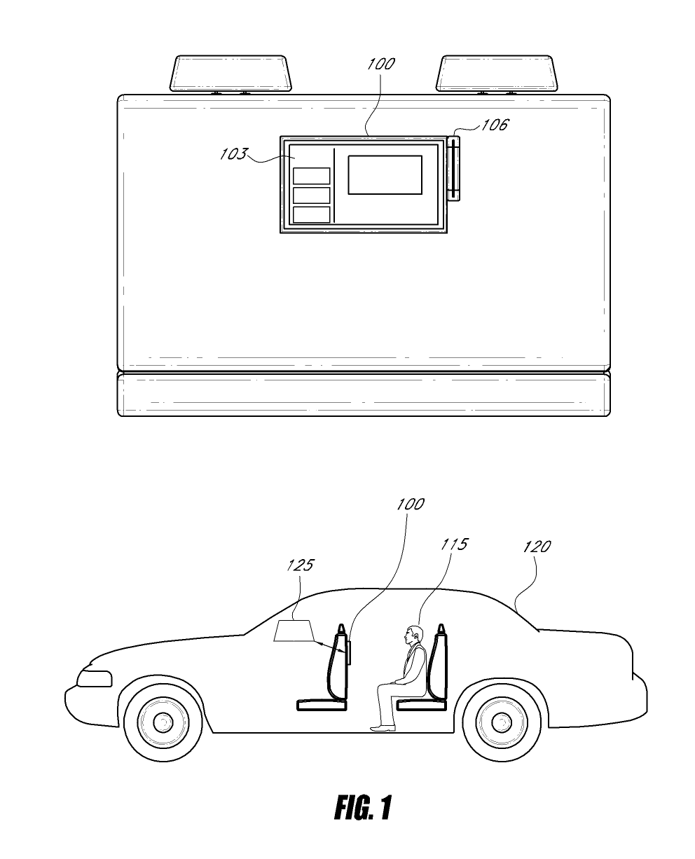

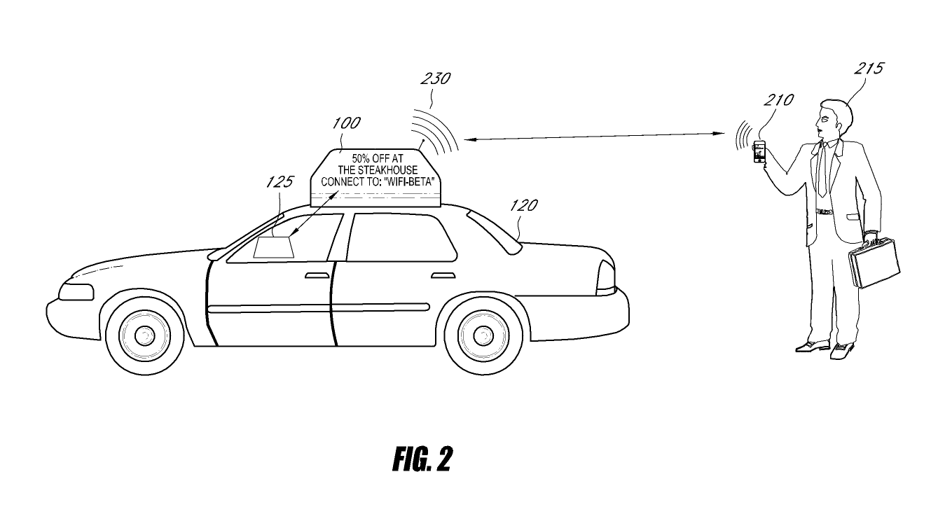

FIGS. 1 and 2 show two illustrative embodiments of deal presenter computer systems (“deal presenter”). The discussion of FIGS. 1 and 2 is meant to provide the reader with an overview of the systems and methods described herein and should not be construed as limiting embodiments. The functionality described with respect to FIGS. 1 and 2, and throughout this application, may be embodied in various ways and still achieve the same desired result.

FIG. 1 illustrates one embodiment of deal presenter 100 in operation within for-hire vehicle 120. In the illustrative embodiment of FIG. 1, deal presenter 100 may be connected to the back of the front seat of FHV 120. Deal presenter 100 may receive a plurality of advertisements, or deals, for special rates that may be offered by a vendor. For example, deal presenter 100 may receive a deal for providing a special rate, such as $20 off, for a variety show, or it may provide a 30% discount at an upscale restaurant at a particular time. Once the deal is received, deal presenter 100 advantageously displays the deal on display 103 so that passenger 115 may view it. The deal may include information related to the offer that may entice passenger 100 to accept the deal. For example, if the deal is for a variety show, favorable reviews of the show may be included in the deal information. For events with fixed seating, the deal may include seating location information, or may include the option to select from the seats available at the deal price. The deal may also include information related to the regular price of an event so that passenger 115 may know the quality of the current deal being offered to him. For example, if the deal is for one ticket to a show for $50, display 103 may provide information to passenger 115 that the usual price for the show is $100. Various other types of information may be shown on display 103 that may entice or persuade passenger 115 to accept the deal.

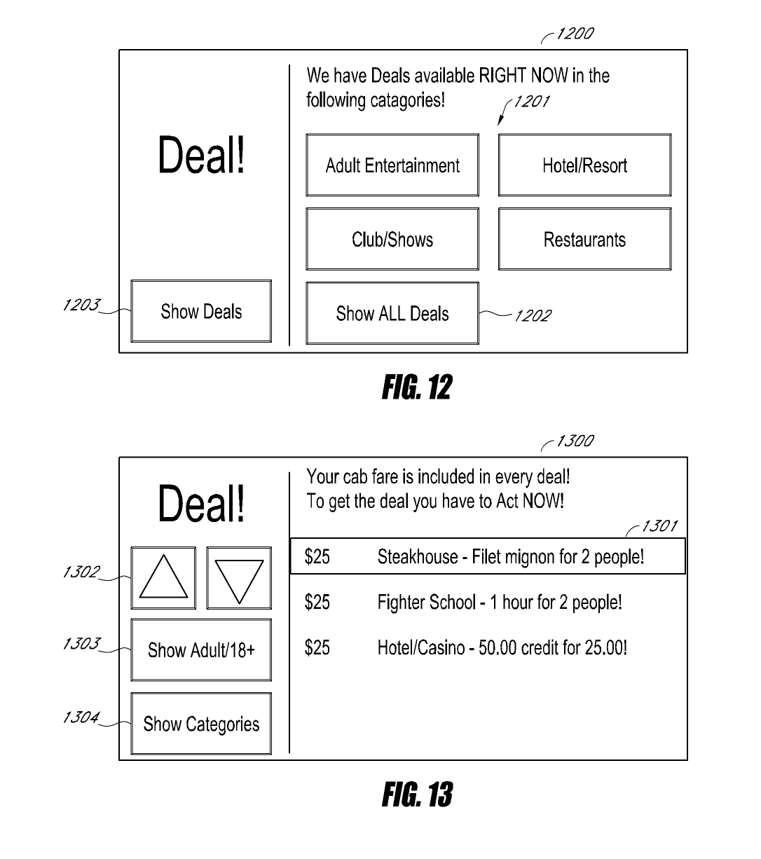

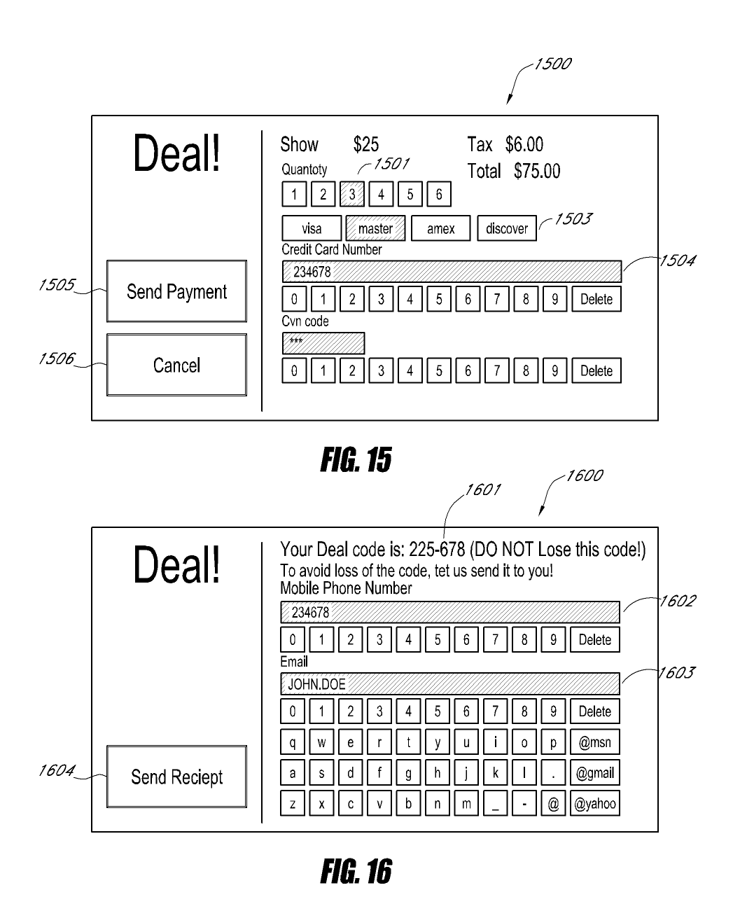

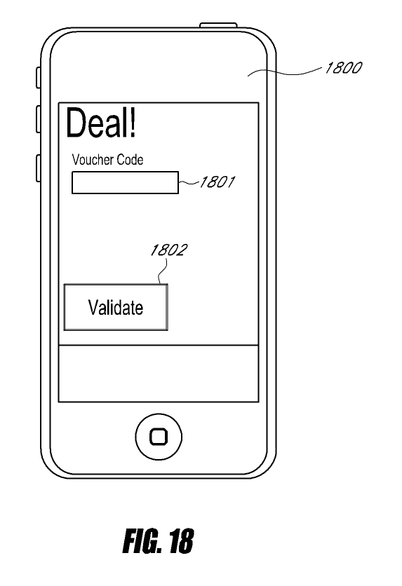

Display 103 may be, in some embodiments, a touchscreen that allows for passenger 115 to make input choices by touching display 103. For example, display 103 may generate graphical buttons for viewing another deal, accepting a deal, or inputting personal information upon accepting a deal. In some embodiments, instead of a touchscreen, display 103 may have a separate input device, such as keyboard, attached to it so that deal presenter 100 may accept user input choices from passenger 115. Examples of the various user interfaces that may be shown on display 103 will be discussed below in greater detail with respect to FIGS. 13-17.

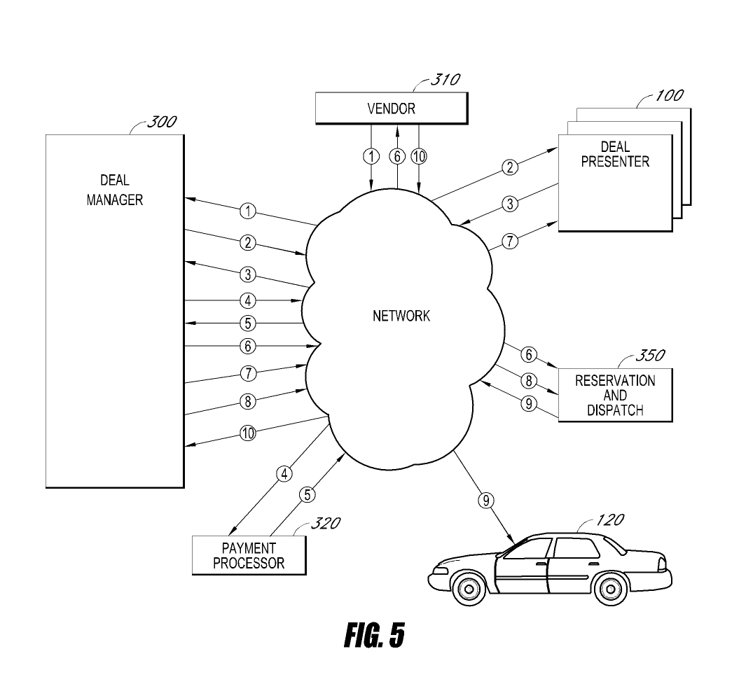

When passenger 115 wishes to accept a deal, the passenger may provide input to deal presenter 100 indicating acceptance of the deal. For example, display 103 may be a touchscreen, that generates an “accept” button that passenger 115 taps to accept the deal. By way of further example, deal presenter 100 may comprise an input button housed on the external surface of the deal presenter unit 100 thereby allowing passenger 115 to accept a deal by depressing the button. Once the deal has been accepted, deal presenter 100 will process the deal acceptance and request payment from passenger 115. Payment may be made, for example, with a credit card. The embodiment of FIG. 1 illustratively shows one method of accepting payment, that is point of sale (“POS”) terminal 106. POS terminal 106 may be connected to deal presenter 100 and may accept a swipe from a credit card, debit card, gift card, or other form of payment as input. Deal presenter 100 may then process the payment information as described further with respect to FIG. 5 below.

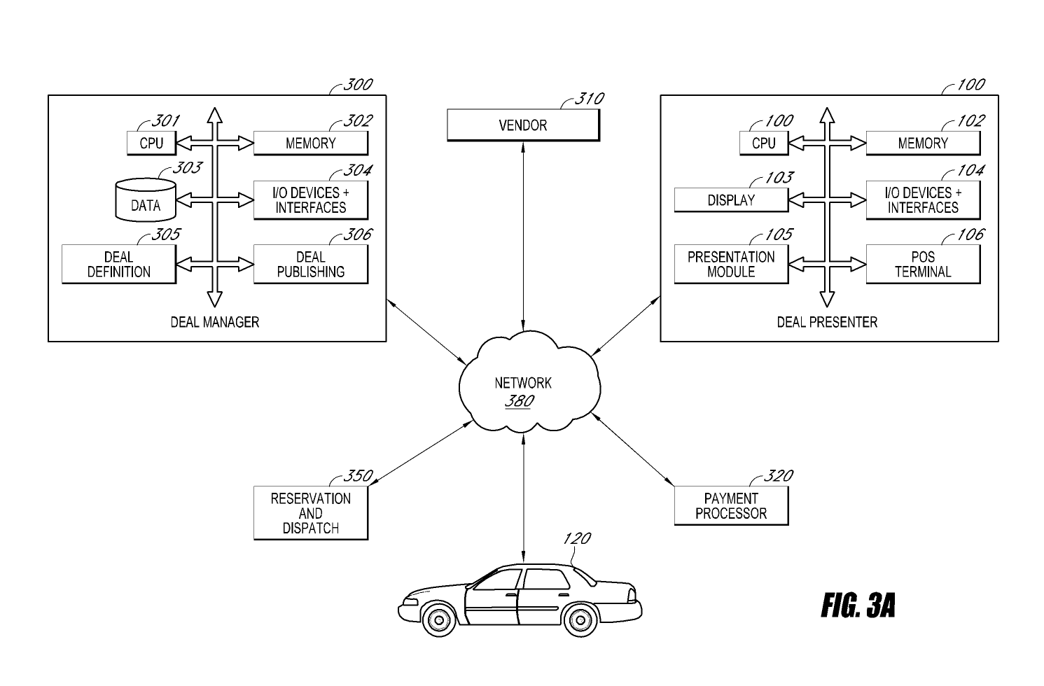

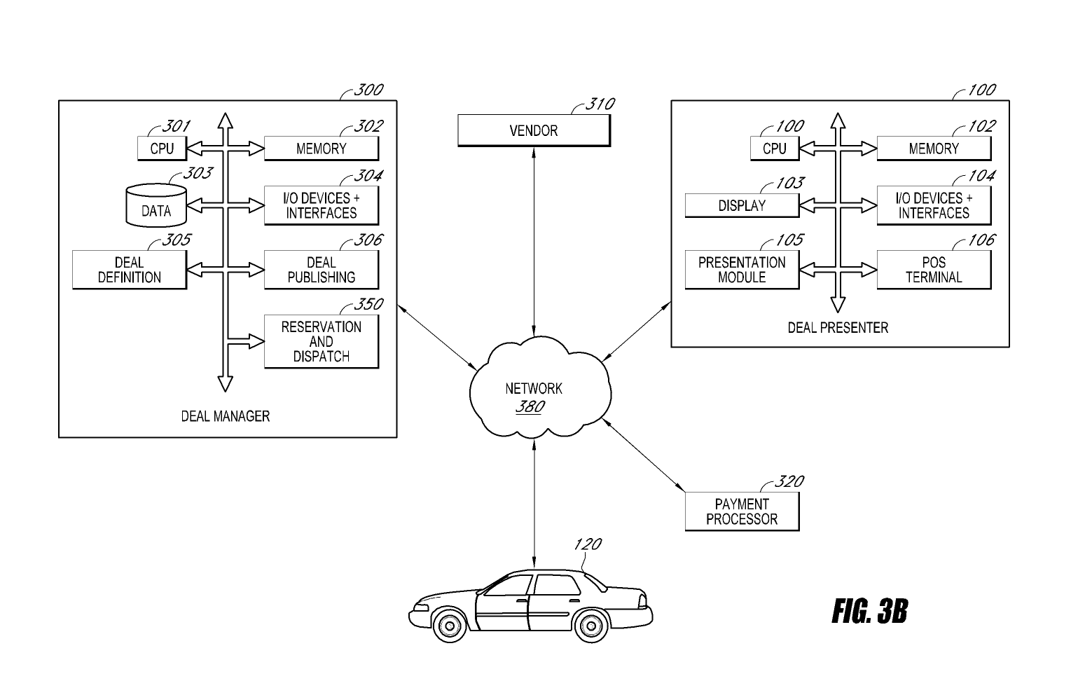

In some embodiments, transportation to the venue providing the deal is included in the purchase price. That is, once passenger 115 accepts the deal and pays the purchase price, FHV 120 will change the passenger's 115 destination from her original destination to the venue offering the deal. In one embodiment, passenger 115 may be en route to a different location and once she accepts the deal, deal presenter 100 may communicate with trip computer system 125 to change the trip information to indicate that passenger 115 will now be traveling to the venue offering the deal. For example, passenger 115 may be traveling in FHV 120 en route to her hotel. Deal presenter 100 may then display a deal to go to a show. Passenger 115 accepts the deal, which includes transportation to the show. Once passenger 115 accepts and pays for the deal, deal presenter 100 may then communicate with trip computer system 125 to update the destination information and change it from the passenger's hotel, to the location of the show. The FHV would then change the passenger's desired destination the passenger from the hotel to the show. In one embodiment, deal presenter 100 is directly connected to trip computer 125 and updates to the passenger's trip occur through communications between deal presenter 100 and trip computer 125. In other embodiments, deal presenter 100 may send notification of the deal acceptance to deal manager 300 (discussed in FIG. 3A) which may then send a message to FHV 120 to update the passenger's trip information in trip computer system 125. Deal presenter 100 may, as discussed in greater detail below, adjust the offer price of the deal so that the current fare accumulated by passenger 115 is included within the deal.

In some embodiments, FHV 120 may be an autonomous vehicle. An autonomous vehicle is a vehicle that drives itself without direct human intervention. An autonomous vehicle may use artificial intelligence, sensors and GPS to coordinate and operate itself without active intervention by a human operator. Google and Volkswagen are two companies that have developed technology related autonomous vehicles. Although autonomous vehicles do not necessarily need a human “driver”, many embodiments allow for an operator to override the auto-driving features for safety reasons. In autonomous vehicle embodiments, once passenger 115 accepts and pays for a deal, deal presenter 100 may then communicate with trip computer system 125 to update the destination information and change it from the passenger's original destination, to the location where the deal may be redeemed. Since FHV 120 is an autonomous vehicle, it will automatically transport passenger 115 to the deal location. The embodiments described herein apply to autonomous vehicles as well as FHVs that are controlled by a human driver.

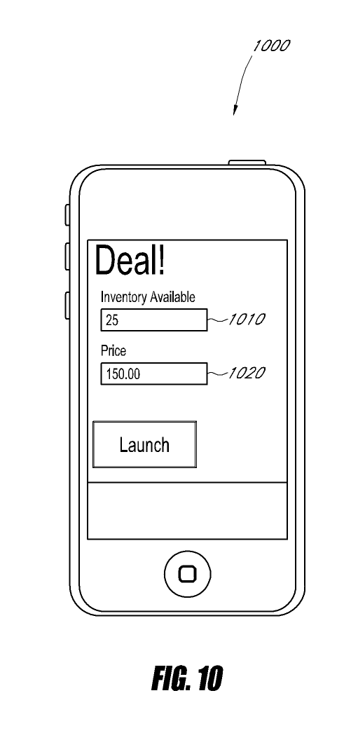

Turning now to FIG. 2, another embodiment of deal presenter 100 is shown wherein deal presenter 100 is affixed to the roof of FHV 120 (“FHV-top display”). The FHV-top-display may be, for example, a programmable LCD screen that may advantageously display one or more deals on a rotating basis. For example, if deal presenter 100 receives two deals, a first offering 50% off at a steakhouse, and a second offering show tickets for $20, deal presenter may display the steakhouse offer for sixty seconds, display the show offer for sixty seconds and then display the steakhouse offer again. Through the use of the FHV-top-display, deal presenter may advantageously attract consumer 215 who may be walking on the street. Advantageously, deal presenter 100 may provide network connection point 230, which may be a wireless access point, or mobile hot-spot, so that consumer 215 may accept a deal using a Wi-Fi enabled mobile device 210, for example. In one embodiment, deal presenter 100 may display a deal along with connection information that consumer 215 may use to connect mobile device 210 to deal presenter 100 so that consumer 215 may accept the deal. For example, in the illustrative embodiment of FIG. 2, consumer 215 may connect to deal presenter 100 through the “Wifi-Beta” wifi network, Once connected, mobile device 210 may include a graphical display that may show user interfaces comprising deals and input means that allows consumer 215 to accept deals. The types of user interfaces shown on consumer computing device 215 may be similar to the user interfaces described with respect to FIGS. 11-17.

Once consumer 215 accepts the deal displayed by deal presenter 100, consumer 215 may pay for the deal with mobile device 210. For example, consumer 215 may enter their credit card information using the input devices and displays that are part of mobile device 210. In some embodiments, an acceptance message may then be sent from mobile device 210 to network connection point 230 of deal presenter 100. Upon receipt, deal presenter 100 may, as described in greater detail below, send an acceptance message to deal manager 300 (see FIG. 5). Deal manager 300 may manage payment processing associated with the deal and may interface with reservation and dispatch computing system 350 so that transportation for consumer may be arranged, for example through making a for-hire vehicle request on behalf of the consumer. (In one embodiment, deal manager 300 may comprise modules that handle the reservation and dispatch of FHVs as shown in FIG. 3B). In some embodiments, deal presenter 100 may be connected to trip computer 125, and once deal presenter 100 receives notification that a deal has been accepted, it may send a dispatch message to trip computer 125 so that the FHV may be directly dispatched to pick up consumer 215 and transport him to the venue offering the deal.

In one embodiment, consumer 215 may install a dedicated deal application on mobile device 210. The deal application may be configured to receive deal offers and display them on screen so that consumer 215 may accept them, thereby making consumer computing system 210 an embodiment of deal presenter 100. The deal application may advantageously allow for consumer 215 to browse currently available deals, and may, as opposed to the illustrative embodiment of FIG. 2, permit consumer 215 to accept a deal without being in the presence of FHV 120. Once consumer 215 accepts the deal through the application, mobile device 210 (acting as a deal presenter 100) may then communicate to acceptance to deal manager 300. Deal manager 300 may then reserve a FHV to transport the consumer 215 to venue offering the deal. In some embodiments, deal manager 300 may be in communication with reservation and dispatch computing system 350. In other embodiments, deal manager 300 may comprise modules that handle the reservation and dispatch of for-hire vehicles (as shown with respect to FIG. 3B). In one embodiment, deal presenter 100 may leverage the location features of consumer computing device to communicate the location of consumer 215 when reserving the FHV. For example, if consumer computing system 210 is a mobile phone, deal presenter 100 may use the GPS chip of the mobile phone to communicate geospatial location information to the FHV reservation computing system.

### Illustrative System Architecture

FIG. 3A is a block diagram illustrative of one embodiment of a deal manager computer system (“deal manager”) 300 in communication over network 380 with a deal presenter computer system (“deal presenter”) 100, a vendor computer system (“vendor system”) 310, a payment processor 320, a reservation and dispatch computer system (“reservation and dispatch”) 350 and for-hire vehicle 120 (“FHV”), which may comprise one or more computing systems controlling its operation. While FIG. 3A may illustrate deal manager 300, deal presenter 100, vendor system 310, payment processor 320, reservation and dispatch 350 and FHV 120 as separate computing systems or modules, the functionality provided for in the systems and modules of FIG. 3A may be combined into fewer components and modules or further separated into additional components and modules. For example, while deal manager 300 and reservation and dispatch 350 are shown as separate computing systems, their respective functionality may be embodied as modules with in the same computing system, as shown in FIG. 3B. By way of further example, the functionality of deal presenter 100 may be split among more than one computing system as is shown in the illustrative embodiment of FIG. 2. In addition, while the blocks of FIG. 2 are described in the singular for ease of reference, embodiments may include more than one of each block. For example, in one embodiment, there may be a plurality of deal presenters 100 (as shown in FIG. 5) or there may be a plurality of FHVs 120.

In one embodiment, deal manager 300 is a computing system responsible for managing deals. Deal manager 300 advantageously provides interfaces for vendors to define deals and may accept deal definitions created by vendors. Deal manager 300 also handles the publication of deals to deal presenter 100 and may monitor the currently defined deals for publication. For example, deals may be time restricted, that is, they may only be offered during a fixed period of time defined by a start time and an end time. For example, a deal may run on Oct. 1, 2011 from 5 PM (start time) to 8 PM (end time). Deal manager 300 may execute a process that checks the currently defined deals in the system and publishes them to deal presenter 100 at the start time of the deal. The deal manager advantageously is in periodic communication with the vendor system to confirm that the deals listed are still current and when a deal is sold the vendor system is updated. The frequency of this periodic communication will depend on the type of deal. For example if seats to a show are being offered then the communication with the vendor system needs to be sufficient to prevent the sale of two identical seats. It is contemplated that this communication can be accomplished automatically without the need for human intervention. The Deal manager 300 may also handle the acceptance of the deal. Once deal manager 300 receives notification from deal presenter 100 that a deal has been accepted, deal manager 300 may interface with reservation and dispatch 350 to request a FHV, and it may also interface with payment processor 320 to process payment. Deal manager 300 may also maintain historical data of past deal campaigns for reporting purposes to vendor system 310.

In one embodiment, deal manager 300, is a computing system that is IBM, Macintosh or Linux/Unix compatible. Deal manager 300 may, in some embodiments, include one or more central processing units (“CPU”) 301, which may include one or more conventional or proprietary microprocessors. Deal manager 300 may further include memory 302, such as random access memory (“RAM”) temporary storage of information and read only memory (“ROM”) for permanent storage of information, and data store 303, such as a hard drive, diskette, or optical media storage device. In certain embodiments, data store 303 stores data needed for managing and maintaining deals. In other embodiments, data store 303 might store historical deal information. Embodiments of data store 303 may store data in databases, flat files, spreadsheets, or any other data structure known in the art. Typically, the modules of deal manager 300 are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, deal manager 300 leverages computing and storage services available over the Internet (cloud computing).

Deal manager 300 is generally controlled and coordinated by operating system software, such as the Windows 95, 98, NT, 2000, XP, Vista, Linux, SunOS, Solaris, PalmOS, Blackberry OS, or other compatible operating systems. In Macintosh systems, the operating system may be any available operating system, such as MAC OS X. In another embodiment, deal manager may be controlled by a proprietary operating system, that is one that had been custom made for the purposes of embodying the systems and methods described herein. Conventional operating systems control and schedule computer processes for execution, perform memory management, provide file system, networking, and I/O services, and may provide a user interface, such as a graphical user interface (“GUI”) for display, among other things.

Deal manager 300 may also include one or more commonly available I/O devices and interfaces 304, such as for example, a printer, buttons, a keyboard, a LED display, a monitor, a touchpad, a USB port, a RS 232 port and the like. In one embodiment, I/O devices and interfaces 304 include one or more display devices, such as a monitor, that allows the visual presentation of data, such as fare and operation data, to a user. In the embodiment of FIG. 3A, I/O devices and interfaces 304 provide a communication interface to various external devices. For example, in the illustrative embodiment of FIG. 3A deal manager 300 is in communication with network 380, such as any combination of one or more LANs, WANs, or the Internet, for example, via a wired, wireless, or combination of wired and wireless, connections via a network interface of I/O devices and interfaces 304. The communications interface may also include, for example, ports for sending and receiving data such as a USB port or an RS 232 port.

Deal manager 300 may also include several application modules that may be executed by CPU 301. The software code of the modules may be stored on a tangible computer-readable medium such as for example, RAM or ROM. More particularly, the application modules may include deal definition module 305 and deal publishing module 306.

In general, the word module, as used herein, refers to logic embodied in hardware or firmware, or to a collection of software instructions stored on a non-transitory and/or tangible computer-readable storage, possibly having entry and exit points, written in a programming language, such as, for example, C, C++, C#, or Java. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules may be stored in any type of computer-readable storage, such as a memory device (e.g., random access, flash memory, and the like), an optical medium (e.g., a CD, DVD, BluRay, and the like), firmware (e.g., an EPROM), or any other storage medium. The software modules may be configured for execution by one or more CPUs in order to cause computing systems described herein, such as deal presenter 100 and deal manager 300, to perform particular operations.

It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

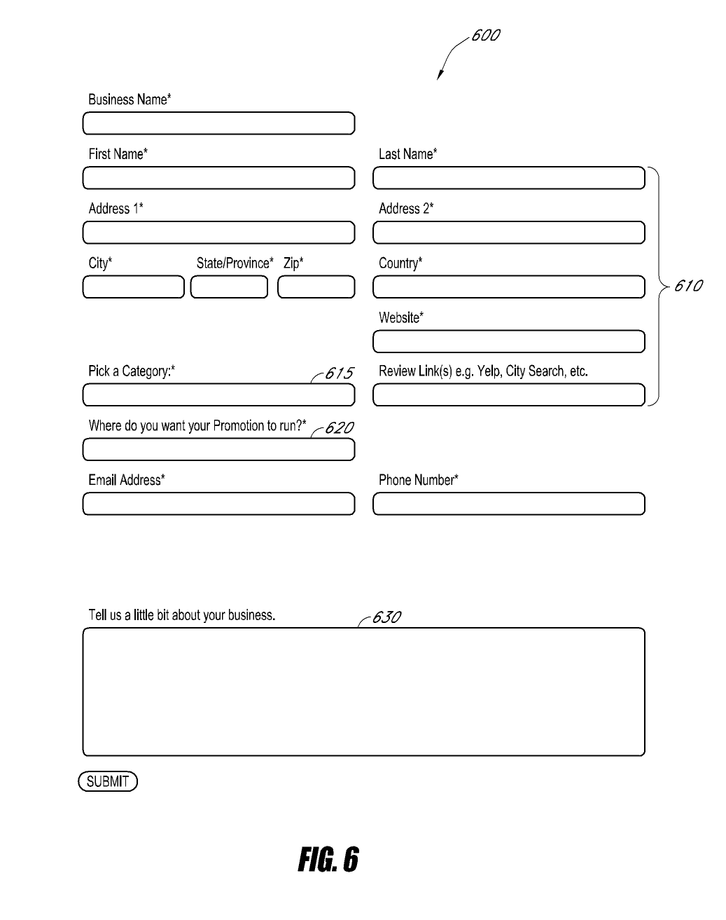

Deal manager 300 may include, in some embodiments, deal definition module 305. Deal definition module 305 may comprise code executed by CPU 301 that is responsible for the definition of deals. For example, deal definition module 305 may generate user interfaces, such as the illustrative user interfaces of FIGS. 6-10, that may be used by a vendor to define a deal. Deal definition module 305 may also handle the processing of deals received by vendor systems 310 and store data associated with the deals in data store 303. Deal definition module 305 may also retrieve deal related data and populate it in the user interface so that vendor may modify deal information. In some embodiments, deal definition module 305 may be programmed with standard options or standard deal parameters that may be used by vendors to facilitate deal definition or provide a template for vendors to define a deal. For example, deal definition module 305 may maintain a list of presentation device types, such as, in-vehicle display, for-hire vehicle display or mobile application so that a vendor may select the presentation devices on which the vendor's defined deal will be published.

In some embodiments, deals may be defined as part of an advertising campaign, that is, a vendor may define a series of deals it may offer, or standard deals it may offer on a regular basis, that are related to the same set of condition parameters triggering the deal offer. For example, if a vendor offers a show in a venue that seats 200 people, the vendor may define a standard deal offering tickets at 50% off if less than 150 seats have been sold by thirty minutes before the show's scheduled start time. Alternatively, a steakhouse may define an all you can eat campaign, that offers a deal for an all you can eat buffet at a special price on Tuesdays. Deal definition module 305 may provide user interfaces or other means for allowing vendors to define a deal campaign. Deal definition module 305 may also comprise code for execution that stores and retrieves data related to vendor campaign.

In one embodiment, vendor system 310 may launch a predefined deal by sending a message to deal manager 300, or more specifically to deal definition module 305, to launch the particular deal. For example, if a vendor predefines a standard deal offering an all you can eat buffet for $10, the vendor system 310 may launch the predefined deal by sending a command to deal manager 300 that the deal should be executed immediately. Vendor system 310 may command the deal manager 300 through a web interface provided by deal manager 300. In other embodiments, vendor system 310 may have installed on it a deal queue application that lists the vendor's predefined deals and may contain options for launching the deal. The application may be a mobile application as shown in FIG. 10 for example, or in other embodiments, may be an application executed on a desktop, laptop, tablet, or other general purpose computing device. In some embodiments, the vendor may define its deal to run for a specific time interval. For example, an all you can eat buffet for $10 may be offered for 45 minutes once it launches. In another embodiment, the deal queue application may provide commands for starting and stopping a deal thereby allowing the vendor flexibility to control deal presentation based on the vendor's needs. For example, a vendor offering an all you can eat buffet may be not be servicing customers at maximum capacity and may therefore wish to offer a 40% discount on the buffet. The vendor may launch the deal queue application and select the predefined deal offering the 40% discount. Using the deal queue application, the vendor system 310 may send a command to deal manager 300 to begin publishing the deal. The deal may result in an increase in business that exceeds the capacity of the vendor. The vendor system may then re-launch the deal queue application, select the currently running deal, and issue a command to deal manager 300 to stop offering the deal.

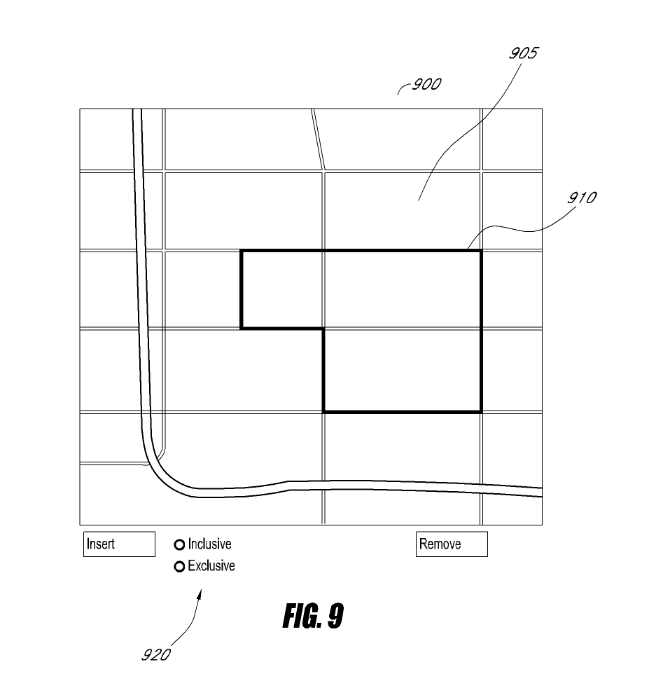

In another embodiments, deal definition module 305 advantageously allows vendor systems to define deal triggers. A deal trigger is a predefined deal with deal offer conditions that must be satisfied before the deal is to be published. The deal offer conditions may relate to the time the deal is offered, the location of where the deal is offered, the current inventory of the vendor, a combination of conditions, or other deal conditions that may be defined by the vendor. For example, a vendor may wish to fill most of its seats for a show prior to show time. The vendor may create a predefined deal that offers the show tickets at 50% off. The vendor may create deal offer conditions associated with predefined deal that will trigger the deal once the conditions are satisfied. The deal conditions may be, for example, “(1) if there are less than 100 seats sold, (2) at 30 minutes before show time, (3) offer the deal for the next 40 minutes.” Once interest is shown in particular seats for example by making the appropriate selection through the deal presenter 100 then the seats are held for a limited time (maybe 5 to 10 minutes) to give the customer the opportunity to complete the payment process. The deal conditions may also be location based. For example, hotels may only wish to present deals to passengers being picked up at the airport, train station, or bus station. In such instances, the vendor may associate a deal condition with their predefined deal indicating the deal should only be presented on deal presenters that are at the airport, train station or bus station. The vendor may create location based deal offer conditions using, for example, a map interface such as the map interface shown in FIG. 9.

In some embodiments, deal manager 300 may comprise deal publishing module 306. Deal publishing module 306 advantageously comprises code that when executed handles the publication of deals and processing of deals once published. For example, deal publishing module 306 may execute a looped process that checks the contents of data store 303 to determine if any defined deals based on time should be published, or if any deal conditions related to deal triggers have been satisfied. Deal publishing module 306 may check the current time and then compare that to the publishing time of a particular deal. If deal publishing module 306 determines a deal should be published, it may then send a message containing the deal, or a “deal packet” out over network 380 that may be consumed by deal presenter 100. Deal packets may contain data related to the deal, such as price of the deal, details of the deal (time, location and/or event information about the deal), and display and formatting information about the deal (such as, for example, HTML code defining how the deal should be displayed on deal presenter 100). The deal packet may also contain code for execution upon passenger 115 or consumer 215 accepting the deal. The code may contain, for example, network information defining where the data should be sent.

In some embodiments, deal publishing module 306 may take a “snapshot” of the current passengers riding in FHVs. The snapshot may include information and data describing the passengers at a particular instant in time. For example, the snapshot may include information about where passengers where picked up or where they may be dropped off and identification information identifying the deal presenter 100 that is affixed to the FHV in which the passengers are traveling. The deal publishing module 306 may then compare the information and data from the snapshot to potential customer attributes defined by a vendor which may define to whom the vendor would like to present deals. If the information and data from the snapshot indicates that some passengers may be interested in the deal, deal publishing module 306 may publish a deal to those passengers. For example, suppose a vendor wants to attract passengers who are staying at luxury hotel. The vendor may set up a customer attribute that indicates they would like to present deals to those passengers who were picked up at the luxury hotel. When there is a need to offer deals, deal publishing module 306 may take a snapshot of the current passengers of FHVs in a location close to the venue of the vendor. If any of those passengers were picked up from the luxury hotel, deal publishing module 306 may publish a deal to those passengers.

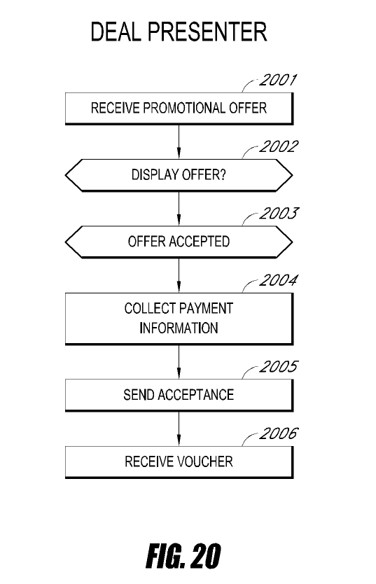

In addition, deal publishing module 306 advantageously processes accepted deals. As described in greater detail below, deal publishing module 306 generally processes payment, generates FHV fulfillments (which may include reserving a FHV or communicated updated trip information to a FHV), generates voucher information, sends confirmations, and then waits for a message indicating a voucher has been redeemed. The processing involved upon deal acceptance is discussed in greater detail with respect to FIG. 19.

Returning to FIG. 3A, deal presenter 100 may be computing system that in responsible for receiving deals, displaying deals and managing the consumer/passenger end of a deal transaction. For example, deal presenter 100 may receive a deal published by deal manager 300. Once received, deal presenter 100 may display the deal so that passenger 115 or consumer 215 may view it. If consumer 215 (or passenger 115) decides to purchase the deal, deal presenter 100 may accept an input criteria indicating deal acceptance and may also collect data such as consumer 215's name, address, current location and payment instrument (such as a credit card) information. Deal presenter 100 may then transmit that information to deal manager 300. Deal presenter 100 may also receive a confirmation message and display the message along with voucher information for consumer 215.

In one embodiment, deal presenter 100, is a computing system that is IBM, Macintosh or Linux/Unix compatible. Deal manager 300 may, in some embodiments, include one or more central processing units (“CPU”) 101, which may include one or more conventional or proprietary microprocessors. deal presenter 100 may further include memory 102, such as random access memory (“RAM”) temporary storage of information and read only memory (“ROM”) for permanent storage of information. Typically, the modules of deal manager 300 are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, deal manager 300 leverages computing and storage services available over the Internet (cloud computing).

As described above, deal presenter 100 may be a dedicated computing system specifically designed to display deals. For example, deal presenter 100 may be a custom in-vehicle display, or it may be computing system that is part of a FHV-top display. In other embodiments, deal presenter 100 may be an application module that executes on a general-purpose computer such as a mobile phone, tablet computing device, laptop computer or desktop computer. In other embodiments, deal presenter 100 may be a module that executes with another application such as a web browser.

Deal presenter 100 is generally controlled and coordinated by operating system software, such as the Windows 95, 98, NT, 2000, XP, Vista, Linux, SunOS, Solaris, PalmOS, Blackberry OS, iOS, or other compatible operating systems. In Macintosh systems, the operating system may be any available operating system, such as MAC OS X. In another embodiment, deal manager may be controlled by a proprietary operating system, that is one that had been custom made for the purposes of embodying the systems and methods described herein. Conventional operating systems control and schedule computer processes for execution, perform memory management, provide file system, networking, and I/O services, and may provide a user interface, such as a graphical user interface (“GUI”) for display, among other things.

Deal presenter 100 may also include one or more commonly available I/O devices and interfaces 104, such as for example, a printer, buttons, a keyboard, a monitor, a touchpad, a USB port, a RS 232 port and the like. In the embodiment of FIG. 3A, I/O devices and interfaces 104 provide a communication interface to various external devices. For example, in the illustrative embodiment of FIG. 3A deal presenter 100 is in communication with network 380, such as any combination of one or more LANs, WANs, or the Internet, for example, via a wired, wireless, or combination of wired and wireless, connections via a network interface of I/O devices and interfaces 104. The communications interface may also include, for example, ports for sending and receiving data such as a USB port or an RS 232 port.

Deal presenter 100 may also include several application modules that may be executed by CPU 301. The software code of the modules may be stored on a tangible computer-readable medium such as for example, RAM or ROM. More particularly, the application modules may include presentation module 105 and POS terminal 106.

In one embodiment, presentation module 105 may include code that determines whether deals should be displayed and may also contain code for generating user interfaces that will be shown on display 103. In some embodiments, the decision logic that determines whether a deal should be displayed may take into account the current time, the current location of deal presenter 100, the current fare accumulated by passenger 115, and demographic information about passenger 115 or consumer 215. Presentation module 105 may maintain in memory 102 a data structure (the “monitor queue”) that stores all published deals it receives and may periodically review the deals in the monitor queue to determine if it should display the deal. The manner in which the monitor queue and the presentation module 105 operate to determine if a deal should be presented is explained in connection with FIG. 21.

In some embodiments, deal presenter 100 may be connected to or include a GPS receiver. The GPS receiver may, for example, be an external GPS receiver that provides GPS coordinates to deal presenter 100 via I/O devices and interfaces 104. In another embodiment, deal presenter may comprise an on board GPS receiver that communicates with the modules and other components of deal presenter 100. In some embodiments, presentation module 105 may correlate received GPS coordinates with known points of interest for the purpose of determining whether to display a deal. For example, presentation module 105 may contain logic for correlating a GPS coordinate with the airport or a particular high-end hotel.

In one embodiment, deal presenter 100 may include POS terminal 106. POS terminal 106 may include hardware and software capable of accepting a payment instrument, such as credit card, debit card or gift card. In some embodiments POS terminal 106 may be a “card swipe” device, for example, a device that reads the payment instrument when a user runs the magnetic stripe of the payment instrument through a grove of POS terminal 106. In another embodiment, POS terminal may include a keypad where a user may input a payment instrument account number. Many commercially available POS terminals exist and such POS terminals may be connected to deal presenter 100 by any means known in the art for connecting POS terminals to computing systems, such as for example, USB.

Turning back to FIG. 3A, reservation and dispatch 350 may be a computing system that is responsible for the reservation and dispatch of FHVs. In one embodiment, reservation and dispatch 350 receives messages from deal manager 300 to request a FHV. The reservation message may contain, for example, the time a FHV should be dispatched, the location where the consumer is to be picked up, and a fixed fare amount for travel. In some embodiments, the FHV should be dispatched immediately, while in other embodiments, the request may be for some time in the future. Once a request message is received, and the time to dispatch a FHV has occurred, reservation and dispatch 350 may send a dispatch message to FHV 120 so that consumer 215 may be picked up at their current location, or a their reserved location, which ever is appropriate for the accepted deal.

In some embodiments, FHV 120 may include dispatch module 125 which has been configured to handle receiving dispatch messages. Dispatch module 125 may be, in some embodiments, a dedicated dispatch computing system. In other embodiments, it may be an application module running on a general purpose computer such as, for example, a mobile phone, tablet, laptop, or other general purpose computing device suitable for in-vehicle use. FHV 120 may also contain a meter, that is, a device used for calculating and reporting fares. In some embodiments, the meter of FHV 120 is advantageously connected to deal presenter 100 to facilitate the accurate calculation of deals based on the current fare accumulated by passenger 115. FHV 120 may also contain a POS terminal for accepting credit card payments for trip fares. The POS terminal may also be connected to deal presenter 100 so that passenger 115 may use the POS terminal to pay for deals in addition to paying for trip fares.

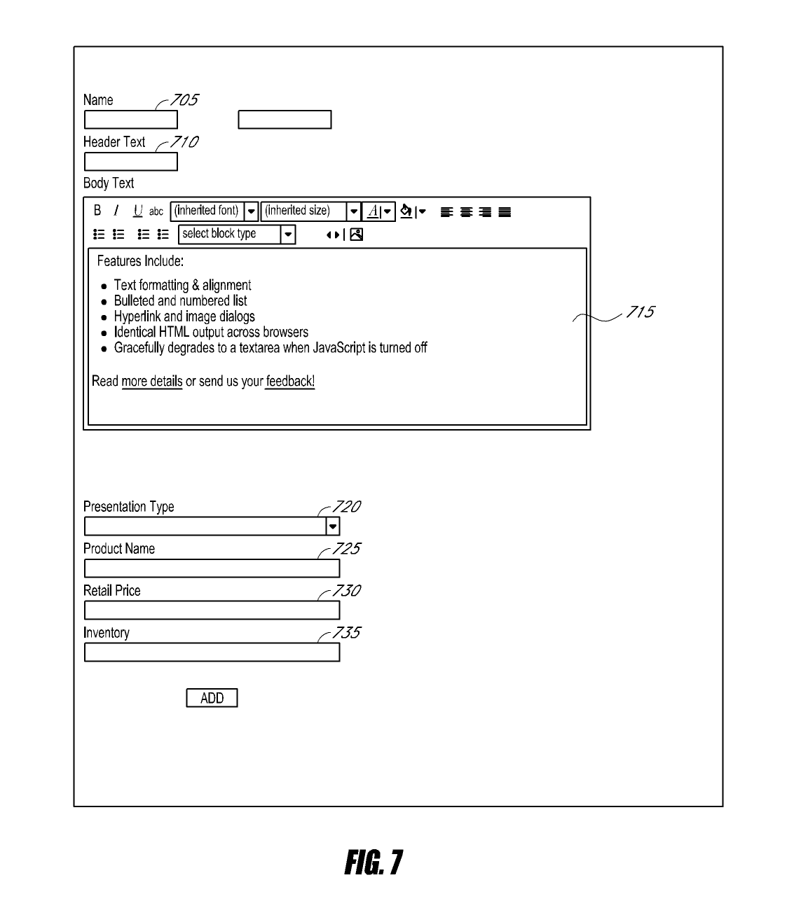

Vendor system 310 may be a computing system that is owned and operated by a vendor that is offering a deal. Vendor system 310 advantageously includes a web browser allowing vendors to register their business (for example, using the illustrative user interface of FIG. 6), or to define deals (for example, using the illustrative user interfaces of FIGS. 7-9). Vendor system 310 may, in some embodiments, be a mobile device, tablet, laptop of desktop. In addition to a web browser facilitating deal definition, vendor system 310 may also contain a dedicated application that is configured to execute on vendor 310 and allow for deal definition using user interface similar to show in FIGS. 6-10.

In some embodiments, vendor system 310 may also include a validation module. The validation module advantageously handled voucher redemption. The validation module may interface with a peripheral device such as UPC code or QR code scanner. In some embodiments, vendor system 310 may be a mobile device, such as a cell phone, that may be equipped with a QR code reader. In such embodiments, the validation module may interface with the QR code reader to receive voucher data from the QR code. In other embodiments, the validation module may interface with a keyboard. A user of vendor system 310 may enter in a voucher number, or serial number, for the voucher using the keyboard in order to redeem the voucher. The keyboard may, in some embodiments, be a virtual keyboard displayed on a touchscreen device such as a tablet computing device. Vendor system 310 may also interface with an interactive voice response (IVR) application in order to validate vouchers. A user may, for example, call the IVR application and read the voucher or serialized identifier over the phone in order to validate the voucher.

Payment processor 320 may, in some embodiments, be a computing system operated by a party appointed by a merchant to handle credit card transactions. For example, payment processor 320 may be a third party entity that handles the credit card transactions entered into POS terminal 106. Generally, payment processor 320 may expose an application program interface (API) that permits outside computer systems, such as deal manager 300, to process credit transactions.

FIG. 3B is a block diagram illustrative of one embodiment of deal manager 300 in communication over network 380 with a deal presenter 100, vendor system 310, payment processor computing system 320, and for-hire vehicle 120 which may comprise one or more computing systems controlling its operation. In the embodiment of FIG. 3B, deal manager 300 comprises reservation and dispatch module 350 which performs the functions of the reservation and dispatch computing system 350 of FIG. 3A. For example, reservation and dispatch module 350 may receive reservations for FHVs and dispatch the FHVs according to received reservations. In addition, reservation and dispatch module 350 may update the trip computers of FHV 120 if passenger 115 accepts a deal while traveling in FHV 120. As references herein, “reservation and dispatch” may refer to either the embodiment illustrated with respect to FIG. 3A or the embodiment illustrated with respect to FIG. 3B.

### Examples of Data Flow and User Interfaces

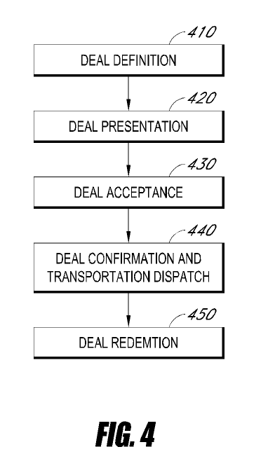

FIGS. 4 and 5 illustrate embodiments of the lifecycle and data flow for a deal from its definition to its redemption. FIG. 4 is a flowchart illustrating a high level view of the lifecycle of a deal. FIG. 5 is a block diagram illustrating the temporal flow of data for the lifecycle of deal from deal definition through deal confirmation.

In FIG. 4, a high level view of the lifecycle of one embodiment of a deal is illustratively described. The high level view of FIG. 4 is meant to provide an overview of the states of a deal. The operations associated with each stage of the deal is described in greater detail below. The lifecycle of a deal begins in box 410 with the definition of the deal. Generally, deals may be defined by those offering the deal such as vendor. Once defined, the deal is presented at box 420. Deal presentation typically involves deal manager 300 communicating deal information to deal presenter 100. Deal presenter 100 may then display the deal. Once displayed, consumer 215 may accept the deal at box 430. Deal acceptance typically comprises the steps of receiving a user input to accept the deal and deal presenter 100 communicating the acceptance to deal manager 300. Once accepted, the deal is confirmed at box 440. Generally, a deal is confirmed by processing payment for the deal, generating a voucher that may be redeemed at venue of the vendor and transmitting the voucher to deal presenter 100, and deal manager 300 reserving a FHV for transporting consumer 215 to the venue of the vendor by communicating with reservation and dispatch 350. Finally, at box 450, the deal is redeemed at the venue. Redemption may also include vendor system 310 communicating validation or redemption data to deal manager 300.

The high level view of the deal lifecycle described in FIG. 4 may now be explained in greater detail using the temporal flow diagram of FIG. 5. FIG. 5 depicts the temporal flow of data between one embodiment of deal presenter 100, deal manager 300, vendor system 310, a payment processor 320, reservation and dispatch 350 and for-hire vehicle 120 (which may comprise one or more computing systems controlling its operation). In particular, the circled numerals of FIG. 5 illustrate the order in which data flows between the various components of FIG. 5 according to one embodiment. In another embodiment, the steps outlined by the circled numerals may be performed in a different order, and the method may include fewer or additional steps.

Generally, the temporal flow of data starts with step 1 where vendor system 310 transmits deal definition data to deal manager 300. Next, at step 2, deal manager 300 publishes deals to deal presenter 100. At step 3, deal presenter transmits a deal acceptance back to deal manager 300. In response, deal manager 300 processes the payment associated with the deal acceptance at step 4 by transmitting payment information to payment processor 320. At step 5, payment processor 320 transmits a confirmation back to deal manager 300 that the payment transaction was successful. Upon receipt of successful payment processing, deal manager 300, at step 6, verifies that the transportation request associated with the deal may be fulfilled by sending a message to reservation and dispatch 350 to insure that a FHV is available to transport the consumer 215 to the venue of the vendor. Once the transportation request has been fulfilled, deal manager 300 transmits a confirmation message containing a voucher for the deal to deal presenter 100 at step 7, and at step 8 transmits a message reserving a FHV to reservation and dispatch 350. Reservation and dispatch 350 then automatically transmits a dispatch notice to FHV 120 thereby dispatching FHV 120 for picking up the consumer who purchased the deal, at step 9. Finally, at step 10, the voucher generated and sent to deal presenter 100 at step 7 is validated and redeemed by vendor system 310 by transmitting a redemption message to deal manager 300.

In step 1 of FIG. 5, vendor system 310 sends information defining a deal to deal manager 300. In one embodiment, vendor system 310 may execute a custom client-based computer application allowing for the user of vendor system 310 to input data defining a deal. Once the data has been entered, the client-based computer application may connect to deal manager 300 and communicate the entered data to deal manager 300, thereby defining the deal. In another embodiment, vendor system 310 may have a web browser application installed and deal manager 300 may comprise a web server that offers web pages to vendor system 310 to input data defining a deal, thereby allowing vendor system 310 to communicate deal definition data to deal manager 300.

FIGS. 6-10 illustrate various user interfaces that may be used to define deals. The user interfaces of FIG. 6-10 may be web pages or user interfaces of a computer application that executes on vendor system 310 that may be in communication with deal manager 300. The user interfaces of FIG. 6-10 are meant as examples and may include more or less user interface elements as desired.

In some embodiments, vendors may register with deal manager 300. Registration may facilitate deal definition so that data related to the vendor is shared among the deals its offers thereby allowing for a more streamlined deal definition process. For example, the address of venue of the vendor may be communicated to deal manager 300 at the time of registration. When the vendor submits deals in the future, the address of the venue need not be entered. FIG. 6 shows one illustrative embodiment of vendor registration user interface 600. Vendor registration user interface 600 advantageously includes vendor information fields 610. Vendor information fields 610 may include, for example, a text field for business name entry, a text field for the first and last name of the contact of the vendor, the address of the venue of the vendor and the website of the vendor. Vendor registration user interface 600 may also include category drop down list 615 which allows for the input of the vendor's category. For example, category drop down list 615 may include categories for selection such as Adult Entertainment, Hotel/Resort, Clubs, Shows, Restaurants, or other categories of vendors. The category may be used to filter deals displayed on deal presenter 100 to passenger 115 or consumer 215. Vendor registration user interface 600 may also include presentation type drop down 620. Presentation type drop down 620 may include the types of deal presenters on which the deal will be displayed. For example, a deal may be presented on a mobile device such as a cell phone, on a FHV-top display or a in-vehicle display. Presentation type drop down 620 may include these deal presentation types, among others. Vendor registration user interface 600 may also include vendor information box 630. Vendor information box 630 allows for vendor 310 to provide additional information about the vendor's business. Deal manager 300 may use the text entered into vendor information box 630 to provide additional services to the vendor or to target advertisements to the vendor, for example.

In some embodiments, the data entered into vendor information box 630 by the vendor may be used by deal manager 300 to generate targeted deals. Targeted deals are deals that may be targeted to certain passengers or consumers based on demographic information or behavior that may be gleaned from their use of FHVs or other information. Data entered into the vendor information box 630 may be used to generate targeted deals by including some of the data in deals that are generated and communicated to deal presenter 100. In another embodiment, the data entered into vendor information box 630 may be used to associate a consumer category with the vendor and the deals the vendor offers. A consumer category may be an indicator of a consumer type. For example, a consumer category may be “affluent traveler”, “businessman”, “family”, “adult entertainment”, “frequent dinner.” Deal manager 300 may use keywords entered into vendor information box 630 to create an association with a consumer category. For example, if the vendor enters “We are an upscale dinning establishment serving fine French cuisine prepared by a world-class chef,” deal manager may detect the keywords “upscale”, “French cuisine” and “world-class chef” to associate the vendor with the “affluent traveler” consumer category. As the vendor defines deals, the deals may be tagged, or associated with the “affluent traveler” category. When the deals are published and communicated to deal presenter 100, the “affluent traveler” consumer category may be included in the deal information. Deal presenter 100 may then use the consumer category as part of its decision to display the deal. For example, as explained with respect to FIG. 21, deal presenter 100 may determine that the current passenger is an “affluent traveler” and as a result, display the deal. In addition or alternatively the vendor input screens may permit the vendor to identify the consumer categories that the vendor has decided that it wants to target.

In some embodiments, the vendor may define deals. The definition of a deal may comprise a title, a description, a price, and a retail price. For example, if the deal is for a show called “Great Show”, the title may be “Deal on Great Show!”, the description may be “The Great Show is an exciting mix of circus arts set to dramatic classical music”, the price may be $25 and the retail price may be $60. A deal definition may also include custom graphics, images, or videos that allow vendor 310 to create an attractive and persuasive deal advertisement for display on deal presenter 100. In some embodiments, deals may be time restricted, that is, they may only run between a first time and a second time. In such embodiments, the deal definition includes the start time and end time of the deal. The vendor may also restrict the areas where deals may run. For example, if the vendor wishes to run their deals on a FHV-top display or on in-vehicle displays, they may limit the display of the deal to a particular predefined area. In such embodiments, the deal definition may also include geospatial parameters that define the area where the deal will run.

Deals may be defined by the vendor using user interfaces provided by deal manager 300, or in other embodiments, by a custom client application executing on vendor 310 that is communication with deal manager 300. FIG. 7 shows one illustrative embodiment of offer detail user interface 700 that may be used by the vendor to define a deal. Offer detail user interface 700 may include, for example, text fields 705, 710 for inputting the name and header text of the deal. The offer detail user interface 700 may also include body text area 715. Body text area 700 may provide a tool bar for formatting and aligning text in the deal. In some embodiments, body text area 700 may accept HTML code as text thereby allowing vendor 310 to format the text that will be displayed in their deal. Body text area may include features that allow bulleted and numbered lists, hyperlink and image dialogs, support across web browsers, or other features known in the art for formatting text. Offer detail user interface 700 may also include presentation type drop down 720. Presentation type drop down 720 may permit the vendor to selection on what type of deal presenter display the deal will be shown. For example, the presentation type drop down may include options such as “In-vehicle Display”, “Vehicle Top”, “Mobile Device” Or “all of the above.” Offer detail user interface 700 may also include a product name text field 725 for inputting a product name. Offer detail user interface 700 may also include a retail price text field 730 which may be used to highlight to passenger 115 or consumer 215 the size of the deal. For example, consumer 215 may recognize that a deal is good if the retail price is $100 and the deal is being offered for $50. In some embodiments, the deal may include an indication that there is a limited supply of deals. For example, for a show, a vendor may only offer 10 seats to the show as a deal. Text field 735 advantageously allows the vendor to input the number of available deals, or inventory, for the deal.

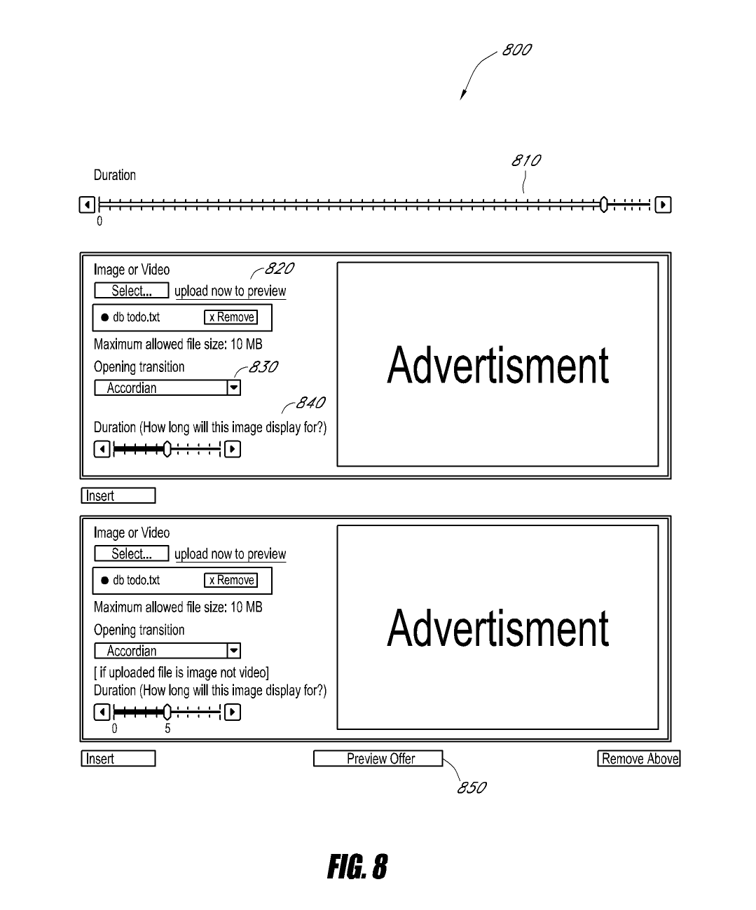

In some embodiments, vendor system 310 may upload media such as images and/or video so that the deal may be more attractive to those that view it. FIG. 8 illustrates one embodiment of media upload interface 800 which advantageously provides user interface elements for uploading media content to deal manager 300 so that the media may be included in the defined deals of the vendor. Media upload interface 800 may include a deal duration slider 810 allowing for the vendor to set the duration for displaying the deal. For example, in the illustrative embodiment of FIG. 8, the slider may be set so that the deal appears for a duration between 0 and 30 seconds. In another embodiment, media upload interface 800 may not include a slider, but rather, may include a text field for entering the duration for displaying the deal. Media upload interface 8 may also include upload element 820. Upload element 820 may be any user interface known in the art permitting upload of files to a server. Upload element 820 may provide a “Select” button. When the user clicks on the “Select” button, a file system dialog box may appear allowing the user to navigate to a directory that may contain a media file for uploading. Once the user selects the appropriate media, the name of the file may appear in text area of upload element 820. In some embodiments, deal manager 300 may only permit files up to a maximum file size. Upload element 820 advantageously informs the user of the max file size. Media upload interface 800 may also include transition drop down box 830. Transition drop down box 830 may contain a list of standard transitions from one image of a deal to the next image of the deal. For example, transition drop down box 830 may include transitions such as accordion (simulating the look and feel of an accordion), blinds (simulating the look and feel of horizontal or vertical blinds) or sweep (simulating the look and feel of the deal sweeping in from the top, bottom, left or right). Media upload interface 800 may also include media duration slider 840 that allows a user to enter the display duration for which the media (as opposed to the entire deal) may be displayed.

In some embodiments, more than one media may be uploaded and included as part of deal. For example, a deal may include several still images, several videos, or a mixture of images and videos. Media upload interface 800 may include buttons for adding additional media. As media is added, the vendor may set the transition and the display duration for each piece of media. In one embodiment, the order the media will be displayed to passenger 115 or consumer 215 is based upon the order the uploaded media appears in media upload interface 800. For example, if image 1 appears at the top of media upload interface 800, and image 2 appears at the bottom of media upload interface 800, consumer 215 will first see image 1 for the length of time set in the media duration slider associated with image 1, and then consumer 215 may see image 2 for the length of time set in the media duration slider associated with image 2. Media upload user interface 800 may also include a preview offer button that allows the vendor to preview the deal thereby allowing the vendor to adjust the media, display duration of media, or transitions between media as needed.

In some embodiments, the vendor may wish to geographically restrict where deals may be presented. FIG. 9 shows one embodiment of geographic restriction user interface 900. Geographic restriction user interface 900 advantageously allows a user to select regions where deals may run, or exclude regions where deals may not run. Geographic restriction interface 900 may permit more than one region of inclusion of exclusion. Geographic restriction user interface 900 may include map element 905. Map element 905 may, in some embodiments, be implemented using a well known mapping tool or API, such as, for example, Google Maps, Falcon View, or any other readily available mapping tool that allows for overlay of graphics. Map element 905 may provide for zoom tools and navigation tools that allows a user to manipulate the map so that they may view the location for where they would like to place a geographic restriction. A user may, for example, select a region of the map with a selection tool and draw border 910 around a region of the map. Once the border has been drawn on the map, the user may select whether the region is to be inclusive or exclusive using radio buttons 920. For example, if the user would like the deal to run only within inside the selected region, then the user would select the “Inclusive” radio button. Geographic restriction interface 900, in some embodiments, may allow for the user to create multiple regions for where deals should be displayed. For example, the user may define a large “inclusive” region, and then define a smaller “exclusive” region inside the large “inclusive” region where the deal would not be offered, if the user (vendor) desired not to present the deal in a particular neighborhood or business area.

In one embodiment, once the vendor has completed entering the deal information using the user interfaces of FIGS. 6-9, the deal information may be communicated by vendor system 310 to deal manager 300 where deal definition module 305 may process the deal definition and store it in data store 303. In some embodiments, deals may be updated. The vendor may access a saved deal through user interface similar to the ones illustrated in FIGS. 6-9. The user interface used for creating a new deal definition may also be used for modifying a deal definition by pre-populating the user interfaces with a saved deal definition information. Deal manager 300 may provide a list in the user interface for the vendor that allows the vendor to select from predefined deals, and may allow the vendor to modify those predefined deals. In some embodiments, vendor system 310 may execute an application for updating a deal definition. Vendor system 310 may be, for example, a mobile computing device with a mobile application. The mobile application may provide the ability to alter details of the deal, such as the price, the time the deal should launch, or deal text. In some embodiments, a predefined deal may be launched on demand. For example, the user of vendor system 310 may wish to launch a deal to stimulate business. FIG. 10 shows one embodiment of user interface 1000 for launching a deal on-demand. User interface 1000 allows for the input of the number of deals available in text field 1010 and the price of the deal in text field 1020. The user interface 1000 also provides launch button 103 which will launch the deal “on-demand.” In another embodiment the functions of the vendor system 310 may advantageously be made a part of the deal manager 300 and the input from the vendor as well as communication with the vendor's in-house inventory management system may be provided through the internet and a browser interface.

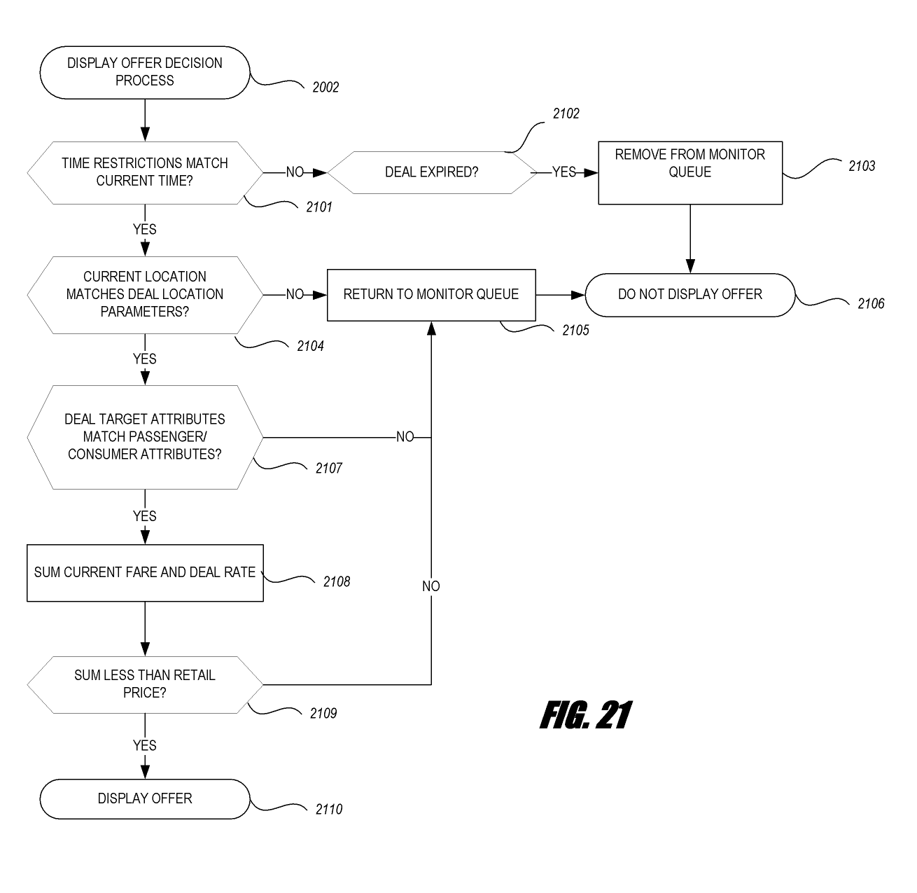

Returning to FIG. 5, at step 2, deal manager 300 publishes the deal. Deal manager 300 may publish the deal in response to a real-time immediate publication request (such as the one issued by the illustrative embodiment of FIG. 10, or it may publish a deal that was defined at an earlier time and stored in data store 303. Deal manager 300 may publish deals by communicating deal information across network 380. In one embodiment, deal manager 300 may publish deals in a broadcast paradigm, that is, deal manager 300 may publish deals without directing the deals to a particular target deal presenter 100, and it is up to deal presenter 100 to determine whether to display the deal. In another embodiment, deal manager 300 may maintain a list of registered deal presenters and may direct deal publication to those deal presenters that satisfy the deal definition. The processes for publishing and displaying deals is discussed further with respect to FIGS. 19 and 20.

Once deal presenter 100 receives the deal, it may display the deal on display 103. FIG. 11 illustrates one embodiment of deal display 1100 that may be displayed showing a promotional offer, or deal, that may be offered to passenger 115 or consumer 215. Deal display 1100 may include deal information 1101. Deal information 1101 may be information related to the deal including the deal name, the deal description, the deal cost, media for the deal (such as images and video), or any other information that was part of the deal definition created by vendor system 310. For example, in the illustrative embodiment of FIG. 11, deal information 1101 includes an indication of how many other passengers have purchased the deal, an image displaying the deal, the number of tickets (deals) available, and the price of the deal. Deal display 1100 may also include a series of graphical buttons 1102, 1103, and 1104 that are configured to receive user input selections. For example, if passenger 115 wishes to purchase the deal, they may select button 1102. If passenger 115 is not interested in the current deal, but rather would like to view other deals, passenger 115 may select button 1103, to see all deals in a list form, or may select button 1104 to show the categories of available deals.

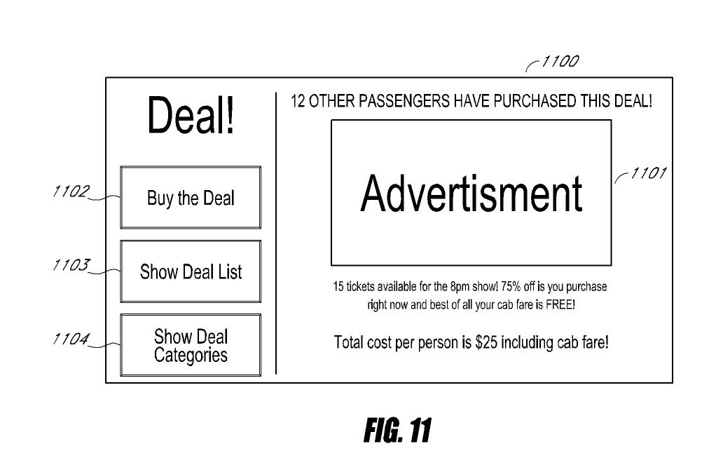

In one embodiment, deal presenter 100 may provide a user interface that allows passenger 115 to browse available deals. FIG. 12 shows one embodiment of category interface 1200 that may be displayed on deal presenter 100. Category interface 1200 may include category buttons 1201. Once selected, category buttons 1201 may show the deals available in a category in a list form (as shown in FIG. 13). Category buttons 1201 advantageously act as a filter, that is, once selected, the deals displayed may be limited to the selected category. For example, if passenger 115 selects the restaurants button, only those deals of the restaurants category (as defined in vendor registration user interface 600, for example) may be displayed. Category interface 1200 may also include a show all deals button 1202. Show all deals button 1202 may show all deals in a list form without filtering the list by category. Category interface 1200 may also provide show deals button 1203 that will return user to deal display 1100, which advantageously displays one deal at a time.

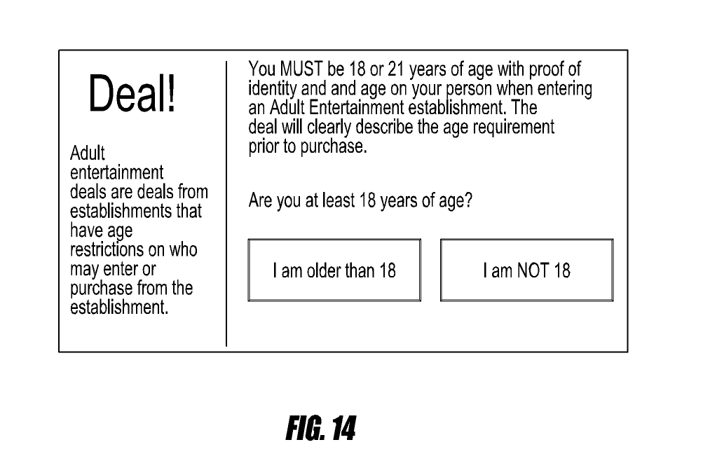

FIG. 13 illustrates one embodiment of deal list interface 1300. Deal list interface 1300 advantageously lists the available deals in list format, thereby allowing passenger 115 to quickly browse the available deals that are currently available for purchase. In one embodiment, the deals in the list are selectable, that is, a user may touch or select the deals in the list and the deal information may then be displayed in a user interface similar to the illustrative user interface illustrated in FIG. 11. The deals displayed in the list may be filtered by category or, in other embodiments, may be filtered based upon whether adult deals have been enabled. Filtering may be canceled through the selection of cancel button 1303. Deal list interface 1300 may also include adult entertainment enablement button 1303 that when selected may display the illustrative user interface of FIG. 14. FIG. 14 illustrates one embodiment of a user interface for enabling display of adult entertainment related deals. The illustrative user interface of FIG. 14 advantageously provides buttons for verifying that passenger 115 is older than 18. Deal list interface 1300 may also comprise Show Categories button 1304 that may return the user to category user interface 1200 when pressed.

In one embodiment, once passenger 115, or consumer 215, selects purchase button 1102, deal presenter 100 may display payment information user interface 1500. Payment information screen 1500 may contain, for example, quantity selection buttons 1501, advantageously allowing Passenger 115 may select the number of tickets he would like to purchase in the deal. The quantity selection may affect payment summary 1502, that is, as the quantity is changed, the total in payment summary 1502 may update. Payment information screen 1500 may also include payment instrument selector 1503, advantageously allowing for the selection of a payment instrument, such as, for example, a Visa card, a Master Card, an American Express card or a Discover card. Payment information screen may also comprise credit card information entry user interface elements 1504 for entry of credit card numbers and CVN codes. Once passenger 115 has entered the appropriate data, passenger 115 may purchase the deal by selecting purchase button 1505. In some embodiments, purchase button 1505 may be disabled, or grayed out, until the passenger 115 has entered the required data for payment processing. If, however, passenger 115 does not wish to purchase the deal, they may exit payment information screen 1500 by pressing cancel button 1506.

Returning to FIG. 5, once passenger 115 indicates they would like to purchase a deal and enters the appropriate payment information, deal presenter 100 communicates the deal acceptance and the payment information to deal manager at step 3. The deal acceptance may also include location information indicating the location of passenger 115 or consumer 215 when accepting the deal. In embodiments where passenger 115 accepts the deal as a result of in-vehicle deal presentation, the location information may not be the absolute physical location of passenger 115, but rather, may be an identifier associated with the FHV in which passenger 115 is traveling. In embodiments where consumer 215 has accepted the deal as a result of a FHV-top display presentation, or personal computing device presentation, the current location of consumer 215 may be communicated to deal manager 300. The current location may be in the form of GPS coordinates obtained from the on-board GPS processor of the mobile device, for example

Once deal manager 300 receives the acceptance from deal presenter 100, deal manager 300 may attempt to process payment in step 4. Deal manager 300 may extract from the acceptance data, payment information that was part of the acceptance. For example, deal manager 300 may extract the payment instrument type selected with payment instrument selector 1503 and may also extract the credit card number and CVN code from the acceptance data. In some embodiments, this data may be encrypted using an encryption algorithm known in the art. In such embodiments, deal manager 300 may decrypt the payment information before packaging it to send to payment processor 320. Payment processor 320 may expose an API allowing payment information to be sent to it. Deal manager 300 and payment processor 320 may communicate using commonly understood methods of communication between computing systems.

Once payment processor 320 receives the payment information it may process it and return the result of processing to deal manager 300 at step 5. If the result of payment processing was successful, deal manager 300 may generate a voucher, voucher number or serialized number (“voucher”) that may be used to redeem the deal at the vendor system 310. The voucher advantageously represents a unique code or key that may be used by passenger 115 or consumer 215 to redeem the deal at the venue of the vendor. The voucher may be a string of alpha-numeric characters, or in other embodiments, may be a UPC code or QR code that will be scanned at the venue. Deal manager 300 may store a record of the voucher creation in data store 303. In embodiments where deals are limited by a fixed inventory, deal manager 300 may also conduct inventory management processing through the use of deal publishing module 306. Deal manager 300 may, for example, decrement an inventory value associated with the deal. For example, if a deal was defined as only having 10 tickets available, the number of tickets available may be adjusted to 9, to indicate that one ticket has been purchased. Deal manager 300 may also broadcast a message to deal presenters indicating that for that deal the number of available tickets has decreased by one thereby allowing deal presenters to update their deal displays.

Once payment has been verified, deal manager 300 may then determine, at step 6, if there is a for-hire vehicle available for transporting consumer 215 to the venue where the deal may be redeemed. Some deals, such as deals for shows or events, are time sensitive. As a result, deal manager 300 may, in some embodiments, make a request of reservation and dispatch 350 to determine if the consumer's transportation request can be fulfilled the estimated pick up time consumer 215. Once the estimated pick-up time is received, deal manager 300 may then use the location information of consumer 215 to estimate the time needed to travel to the venue offering the deal. Using the estimated pick-up time, and the estimated travel time, deal manager 300 may then estimate the length of time it would take for consumer 215 to get to the venue. Once the travel time is determined, it is added to the current time to ensure that consumer 215 will arrive on time for her deal. In the event that a FHV cannot pick up consumer 215 in time for the show or event, deal manager 300 may cancel the deal and refund the consumer's purchase of the deal. In some embodiments, the request to determine if consumer's transportation request can be fulfilled is completed prior to payment processing.

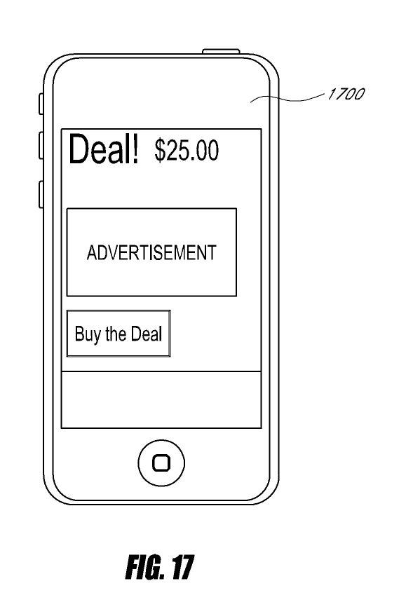

The flow of data then proceeds to step 7 where deal manager 300 then sends the voucher and purchase confirmation to deal presenter 100. FIG. 16 shows one embodiment of deal confirmation user interface 1600. Deal confirmation user interface 1600 advantageously includes voucher 1601. As shown in FIG. 16, voucher 1602 may be an alpha-numeric code, for example “225-678”. In addition to providing the voucher on the display of deal presenter 100, deal confirmation user interface 1600 may also include user interface elements that provide a means for passenger 115 to input contact information so that the voucher may be sent directly to the computing device of passenger 115. For example, deal confirmation user interface 1600 may provide phone number text field 1602 for entry of a phone number corresponding to a mobile phone capable of receiving a text message. In addition, deal confirmation user interface 1600 may also provide email text field 1603 for entry of an email address. Passenger 115 may then a copy of the voucher, along with receipt information, to their personal computing device by selecting send button 1604. In some embodiments, the deal confirmation may include an indication of where consumer 215 is to expect FHV 120 to pick them up to take them to the venue. For example, the deal confirmation may indicate a particular intersection, taxi stand or address where consumer 215 should wait for the FHV to pick her up.

In some embodiments, deal manager 300 may generate a voucher coupon and send it to deal presenter 100. The voucher coupon may be, for example, an image file containing the voucher number and a UPC or QR code. The voucher coupon may also contain information related to the event for which the deal is was purchased. For example, the event name may be on the voucher coupon, and the deal amount may be on the voucher coupon. In some embodiments, deal presenter 100 may have a printer connected to it. For example, if deal presenter 100 is an in-vehicle display, a thermal printer may be connected to deal presenter 100 for printing the received voucher image. In embodiments where deal presenter 100 may be a mobile device, an image may be displayed on the mobile device so that vendor system 310 may scan the UPC code or QR code for redemption. In some embodiments, deal manager 300 may send the generated coupon image in an email to passenger 115 or consumer 215 to the email address entered in email text field 1603.

Also in step 7, deal manager 300 may send to vendor system 310 a confirmation message indication that deal has been purchased. The confirmation message may include identification information of passenger 115 or consumer 215, if available. The vendor may then use the information of the confirmation message as a further check with the validation of the voucher as a means of further preventing fraud. In addition, the confirmation message may indicate, if appropriate, a seat number, position number, or other customer unique identifier to prevent the vendor from double selling a unique item. For example, suppose the vendor is providing a show with fixed seating. The vendor offers several seats for sale, including seat 5A. Seat 5A is then sold in a deal presented on deal presenter 100. The vendor receives confirmation that Seat 5A was sold and as a result, will not then resell Seat 5A to another customer who may walk up to the venue and wish to purchase a seat without a pre-purchased deal. To make sure that two seats are not sold to different customers at the same time the seats are held for short time period (for example 5 to 10 minutes) when the customer has taken the first step to accept the deal. Then if the seat is not purchased within this time period the seat is released.

Moving to step 8, deal manager 300 advantageously sends a FHV request to reservation and dispatch 350 following the communication of the voucher to deal presenter 100 and the confirmation message to vendor system 310. The request may contain the location of consumer 215 and request an FHV to be dispatched to pick up consumer 215. For example, if consumer 215 received a deal on their mobile device at Las Vegas Blvd and Fremont for an event at Las Vegas Blvd and Flamingo, the request may indicate that the passenger is to be picked up at Las Vegas and Fremont and then transported to Las Vegas and Flamingo. The request may also indicate that the fare for the trip has already be paid and will be credited to the driver accepting the fare.

In some embodiments, deal presenter 100 may be an in-vehicle display and passenger 115 may be traveling to a first destination when the deal is displayed and accepted. In this embodiment, the request message may indicate that the request is not for a new dispatch, but rather to edit a current trip sheet. The request may contain the location of passenger 115 and request that the trip destination of passenger 115 be updated to reflect the location of the venue as the new destination. For example, if passenger 115 is traveling in a FHV to Las Vegas and Fremont when he accepts a deal for an event at Las Vegas and Flamingo, deal manager 300 may send a request to reservation and dispatch 350 that the trip taken by passenger 115 be altered so that the destination of Las Vegas and Fremont be changed to Las Vegas and Flamingo.

Once reservation and dispatch 350 receives the request, it may then send a dispatch message to FHV 120 at step 9. The dispatch message may, in some embodiments, be a dispatch to initiate a new passenger fare. In other embodiments, the dispatch message may be a message to update the trip sheet for passenger 115. Once dispatched, the driver of FHV 120 may pick up the passenger and take them to the venue of the vendor.

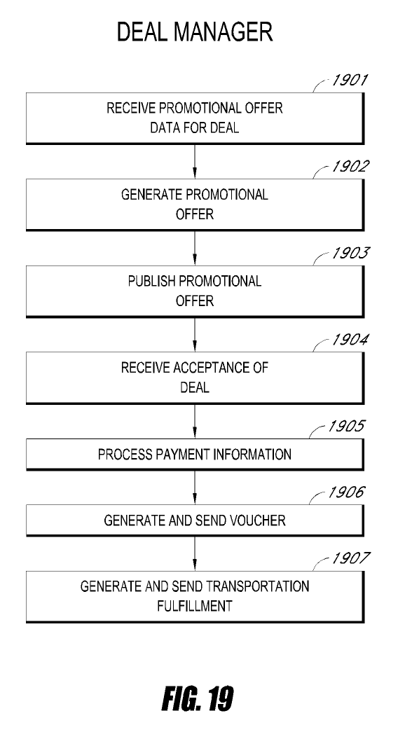

Finally, at step 10, the voucher sent to passenger 115 or consumer 215 may be validated. In some embodiments, vendor system 310 and FHV 120 may have a specialized reader device that may scan UPC or QR codes from voucher coupons. In other embodiments, the voucher code may be submitted by vendor system 310 or the driver of FHV 120 to deal manager 300 through the use of web portal, mobile or IVR application. For example, FIG. 18 illustrates one embodiment voucher redemption interface 1800. In one embodiment, a user may enter an alpha-numeric code into voucher code text field 1801. Once entered, the user may submit the voucher code to deal manager 300 by pressing validate button 1802. In another embodiment, the voucher code may be validated through the use of an IVR application that interfaces with deal manager 300. A user may call a phone number associated with deal manager 300 and read the alpha-numeric voucher code. The IVR application advantageously interprets the voucher code and sends the voucher code information to deal manager 300.

Once deal manager 300 receives the voucher code, deal manager 300 may validate and redeem the deal. In one embodiment, deal publishing module 306 may mark a row in data store 303 corresponding to the voucher indicating that is was redeemed and can no longer be redeemed if the voucher code is valid. In some embodiments, vouchers may be redeemed by drivers (as part of transportation fulfillment) and may also be redeemed by vendors. As a result, deal manager 300 may maintain separate data structures for a voucher code indicating that it has been redeemed once by the driver of FHV 120, and once by the vendor system 310. If the voucher code is not valid, deal manager 300 may send a validation failed message back to vendor system 310 or the driver of FHV 120 indicating that the voucher is invalid.

### Illustrative Process Flows

FIG. 19 is a flow chart depicting the process flow of one embodiment of a deal manager 300. At box 1901, deal manager 300 may receive promotional offer data for a deal from a vendor system 310. The promotional offer data may include deal data as described above with respect to FIGS. 6-10. For example, the promotional offer data may include deal information describing the deal, time restrictions, location restrictions, the number available at that price (checked in real time), a retail price, images, or other data that may define a deal. The deal information may, for example, contain a description of the deal being offered to the consumer. Time restrictions may indicate the time a deal is to run. A time restriction may include a start time, such as 6 PM on Jul. 1, 2011 and an end time, such as 10 PM Jul. 1, 2011. Location restrictions may comprise a plurality of GPS coordinated defining a region where the deal should be presented (“inclusive restrictions”), or defining a region where the deal should not be presented (“exclusive restrictions”). The retail price may be an indication of the regular price of the item offered in the deal.

In response to the received promotional offer data, deal manager 300 may generate a promotion offer, or deal, at box 1902. The deal or promotional offer may include some of the promotional offer data. In addition, the promotional offer may include a consumer category. The consumer category may describe the type of customer that may be interested in purchasing the deal. For example, a consumer category may be “affluent traveler”, “businessman”, “family”, “adult entertainment”, “frequent dinner.” Once the promotional offer is generated, deal manager 300 may publish the deal according to methods described in the present disclosure. For example, deal manager 300 may publish the deal in a broadcast paradigm. Once the promotional offer publishes, deal manager 300 may wait for one or more acceptances of the promotional offer.

At box 1904, deal manager 300 receives the acceptance of a deal. Once the acceptance is received, deal manager 300 extracts location information and payment information from the acceptance. The location information indicates the location of deal presenter 100 at the time of acceptance. The payment information includes data related to the amount paid and the account number of the payment instrument. Deal manager 300 then, at box 1905, sends the payment information to payment processor 320 for processing. Once the payment successfully processes, deal manager 300 may generate a voucher and send it to deal presenter 100 at box 1906. Finally, at box 1907, deal manager 300 may generate and send a transportation request to reservation and dispatch 350 based on the extracted location information.

FIG. 20 is a flow chart depicting the process flow for one embodiment of a deal presenter 100. At box 2001, deal presenter 100 receives a promotional offer. Once received deal presenter 100 may add the promotional offer, or deal, to a monitor queue. The monitor queue may be a list of received deals that are analyzed on a periodic basis to determine if all the restrictions, such as time and location based restrictions for example, associated with the deal are satisfied. In some embodiments, the received deal may be added immediately to the monitor queue before being analyzed, while in other embodiments, the deal is analyzed to determine if it should displayed immediately or added to the monitor queue. Once the deal is added to the monitor queue, deal presenter 100 may periodically analyze the deals in the monitor queue to determine if they should be displayed. At box 2002, the deal presenter 100 determines if it should display the offer.

FIG. 21 is a flow chart depicting the process flow for one embodiment of a deal presenter 100 showing one illustrative example of a display offer decision process. The process shown in FIG. 21 describes just one process for determining whether to display a deal on deal presenter 100 and it should be understood that other processes and methods may be used to determine when deals should be displayed. For example, another method of determining whether deals should be displayed may be for deal presenter 100 to display all deals it receives. It should also be understood that in some embodiments, some steps of the process depicted in FIG. 21 may not be performed. For example, in some embodiments, deals may not be matched to passengers or consumers based on target attributes as described with respect to box 2107. In one embodiment, the process shown in FIG. 21 is advantageously performed by presentation module 105.

At box 2101, presentation module 105 determines if the time restrictions match the current time. If the time restrictions match the current time, then processing moves to box 2104. For example, a deal may have a time based restriction that it is to run from 1 PM on April 4 to 10 PM on April 5. Presentation module 105 may determine that the current time is 1:01 PM on April 4. As a result, processing may move to block 2104. If, however, the time restrictions do not match the current time, processing moves to box 2102, where the presentation module 105 determines if the deal has expired and should be removed from the monitor queue. Using the above example, if the current time is 10:03 PM on April 5, the deal has expired. As a result, presentation module 105 will remove the deal from the queue at box 2103. If, however, the current time is earlier than the start time, for example, 12:30 PM on April 4, the deal is returned to the monitor queue at box 2105 and is not displayed. Another example is that the deal would be removed from the monitor queue if all the inventory (of seats for example) have been sold.

When the time restrictions are satisfied, processing moves to box 2104 where presentation module 105 determines if the current location matches the deal location parameters. The determination may depend on the current location of deal presenter 100. For example, suppose deal presenter 100 receives a deal that is geographically restricted to areas north of Interstate 215. The deal would enter the monitor queue along with other received deals. When presentation module 105 examines the deal from the queue, it will determine the current location of deal presenter 100. Presentation module 105 may, for example, determine its location through the use of a GPS unit connected to deal presenter 100 (in the case, for example, of an in-vehicle deal presenter) or it may use a GPS that is part of deal presenter 100 (in the case of a mobile phone application deal presenter or an in-vehicle deal presenter, for example). If deal presentation module determines that deal presenter 100 is in a FHV that is south of Interstate 215, presentation module 105 may not display the deal, but instead leave the deal in the monitor queue to be re examined later at box 2105. In some embodiments, presentation module 105 may store the deal in memory and then display the deal when deal presenter 100 travels north of Interstate 215, and processing may continue to box 2107.

At box 2107, the presentation module 105 determines if the deal target attributes match the attributes of the passenger or consumer viewing the deal presenter 100. The deal target attributes may, in some embodiments, be a consumer category. The deal may contain a consumer category that described a target consumer to which the deal should be displayed. The presentation module 105 may also decide whether the current consumer or passenger is of the same consumer category. In embodiments where deal presenter 100 is installed in a FHV, presentation module 105 may determine the passenger's consumer category based on information related to the passenger's trip. For example, if the FHV is a limo, as opposed to a shuttle or taxi, presentation module 105 may determine that the passenger is of the consumer class “affluent traveler” or if the FHV is a mini-van, as opposed to sedan, the presentation module 105 may determine the passenger is of the consumer class “family.” Presentation module 105 may also use the pick-up location, or current destination location, to glean information about the passenger that may be used to determine the consumer class for the passenger. For example, if the passenger is picked up at a high end hotel and is planning on traveling to a sushi restaurant, presentation module 105 may determine that the passenger is of the “affluent traveler” and “frequent diner” consumer categories. In embodiments where deal presenter 100 is a mobile device or other general purpose computing system, a consumer category may be determined from the consumer's prior deal purchase history, or consumer entered attributes. In some embodiments, instead of or in addition to consumer categories, destination information may be used to match deals with a passenger. For example, if the passenger is traveling to an adult entertainment venue, presentation module 105 may match the passenger with deals for other adult entertainment venues in the hope of the passenger changing his or her desired destination.

Once presentation module 105 determines that the deal target attributes match the passenger or consumer attributes, processing continues to box 2108. At box 2108, the total cost of the deal is determined. In some embodiments, deal presenter 100 may not present a deal if the deal does not provide a discount once the current accumulated fare is included in the deal. Accordingly, presentation module 105 sums the current accumulated fare and the deal rate at box 2108 after which processing moves to box 2109 to determine if the summed value is less than the retail price of the deal. For example, deal presenter 100 may receive a deal for $20 tickets for $10. If, however, passenger 115 has accumulated a fare of $12, the accumulated fare, plus the cost of the deal of $10 may result in a cost of $22 to accept the deal. Thus, presentation module 105 may not display the deal because the cost of accepting the deal for the ticket exceeds what the ticket would normally cost and the deal is returned to the monitor queue at box 2105. If, however, presentation module 105 determines that the accumulated fare plus the deal rate results in a deal price that is lower than the retail price, processing may move to box 2010, and the deal may be displayed. In another embodiment the functions of the presentation module 105 of the deal presenter may advantageously be handled as part of the deal manager 300. In this embodiment the deal manager would keep track of all the current information about the for-hire-vehicles in the overall system including for example location and fare status as well as what ever information is known about the passenger(s). This information would then be used to make the decision about where and when to present the offers available.

Returning to FIG. 20, if deal presenter 100 decides to display the promotional offer, it may then determine if the promotional offer has been accepted at box 2003. If the offer is accepted, payment information is collected at box 2004. The payment information may be collected, in some embodiments, through the use of a POS terminal. Once the payment information has been received, deal presenter 100 may send the acceptance to deal manager 300. Finally, at box 2006, deal presenter 100 may receive confirmation that the promotional offer has been processed and deal presenter 100 may receive a voucher that can be redeemed at venue 310.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A method of providing a promotional offer by a deal manager that includes a processor and a storage medium storing processor readable instructions, the method comprising:
receiving, by a deal manager, promotional offer data from a vendor computer system;
generating, by the deal manager, a promotional offer based at least in part on the promotional offer data;
communicating, by the deal manager, the promotional offer to a deal presenter;
receiving, by the deal manager, a reply to of the promotional offer, the reply comprising:
acceptance data providing an indication of whether a customer has accepted the promotional offer;
customer location data providing an indication of a location where the customer accepted the promotional offer;
payment data providing an indication of:
a method of payment and,
a payment amount;
in response to receiving the reply:
generating, by the deal manager, a voucher comprising a deal code;
communicating, by the deal manager, the voucher to a customer device;
generating, by the deal manager, a dispatch message comprising the customer location data and vendor location data providing an indication of where the deal code may be validated; and,
communicating the dispatch message to a dispatch center the dispatch center capable of dispatching a for-hire vehicle to the location indicated in the location data.

2. The method of claim 1 wherein the response further comprises contact information of the customer.

3. The method of claim 2 further comprising, communicating, by the deal manager, the deal code to the customer using the contact information.

4. The method of claim 3 wherein the contact information comprises a phone number of a phone capable of receiving a text message.

5. The method of claim 3 wherein the contact information comprises an email address.

6. The method of claim 3 wherein the contact information comprises a web site address.

7. The method of claim 1 wherein the voucher is a paper voucher.

8. The method of claim 1 wherein the voucher is a graphical image capable of being displayed on a computer display.

9. An in-vehicle promotional offer system, the system comprising:
a display affixed to a vehicle;
a point of sale terminal configured to accept a payment instrument;
a computer readable medium storing instructions performing the steps of:
receiving a promotional offer in the form of processor readable data from a deal manager, the promotional offer comprising location information associated with a vendor;
displaying the promotional offer on the display;
receiving an acceptance indication from a consumer;
receiving, from the point of sale terminal, payment information associated with the acceptance indication;
communicating the acceptance indication and the payment information to the deal manager; and,
communicating to a for-hire vehicle computer system the location information associated with the vendor.

10. The system of claim 9 wherein the computer readable medium storing instructions further perform the steps of:
receiving contact information from the consumer; and,
transmitting a voucher to the consumer based at least in part on the contact information.

11. The system of claim 10 wherein the contact information comprises a phone number of a phone capable of receiving a text message.

12. The system of claim 10 wherein the contact information comprises an email address.

13. The system of claim 10 wherein the contact information comprises a web site address.

14. The system of claim 9 further comprising a printer and wherein the instructions the computer readable medium storing instructions further performs the step of printing a voucher.

15. The system of claim 14 wherein the voucher includes a voucher code.

16. The system of claim 14 wherein the voucher includes a UPC code.

17. The system of claim 14 wherein the voucher includes a QR code.

18. A computer readable medium storing software instructions that when executed cause a computer system to perform the steps of:
receiving a response to a promotional offer, the response comprising:
acceptance data providing an indication of whether a customer has accepted the promotional offer;
customer location data providing an indication of a location where the customer accepted the promotional offer;
payment data providing an indication of:
a method of payment and,
a payment amount;
in response to receiving the acceptance:
generating, a voucher, the voucher comprising a voucher code;
communicating, the voucher to a customer computing system;
generating a dispatch message comprising the customer location data and vendor location data providing an indication of where the deal code may be validated; and,
communicating the dispatch message to a dispatching computer system, the dispatching computer system capable of dispatching a for-hire vehicle to the location indicated in the location data.

19. The computer readable medium of claim 18 wherein the software instructions when executed further cause the computer system to perform the steps of:
receiving promotional offer data from a vendor computer system;
generating a promotional offer based at least in part on the promotional offer data;
communicating the promotional offer to a deal presentation computer system.

20. The computer readable medium of claim 18 wherein the response further comprises contact information of the customer.

21. A method of displaying a promotional offer by a computer that includes a processor and a storage medium storing processor readable instructions, the method comprising:
accessing promotional offer information comprising consumer target data, the consumer target data comprising attributes describing consumers that are likely to visit a venue;
determining consumer description information for a consumer traveling in a for-hire vehicle, the determining based at least in part on an origin location describing where the for-hire vehicle picked up the consumer or a destination location describing where the for-hire vehicle has been hired to transport the consumer;
comparing the consumer target data to the consumer description information; and,
displaying a promotional offer to the consumer if comparing the consumer target data to the consumer description information results in a determination that the consumer matched the consumer target data of the promotional offer.

22. The method of claim 21,
wherein the promotional offer information further comprises display time data, and
the method further comprises determining a current time and displaying the promotional offer to the consumer if display time data and a current time indicate the promotional offer should be displayed.

23. The method of claim 21,
wherein the promotional offer information further comprises display location data, and
the method further comprises determining a current location and displaying the promotional offer to the consumer if the display location data indicates that the promotional offer should be displayed at the current location.

24. The method of claim 21, further comprising:
receiving a response to the promotional offer, the response comprising:
an indication of an acceptance of the promotional offer, and
consumer payment information for paying for the promotional offer.

25. The method of claim 21, further comprising:
receiving a response to the promotional offer; and,
generating a dispatch message comprising an indication of a location where the promotional offer may be redeemed.

26. An offer display system comprising:
a display unit;
a wireless access point;
a storage medium storing processor readable instructions that when executed cause a processor to:
receive offer data, the offer data comprising an offer and a venue location associated with the offer;
display, on the display unit, at least some of the offer data,
display, on the display unit, connection information for connecting to the wireless access point;
receive, via the wireless access point, an acceptance to the offer sent from a consumer computing device, the acceptance comprising a consumer location;
generating a for-hire vehicle request, the for-hire vehicle request comprising the venue location and the consumer location.

27. The system of claim 26 wherein the processor readable instructions, when executed, further cause the processor to communicate the for-hire vehicle request to a dispatch center.

28. The system of claim 26 wherein the processor readable instructions, when executed, further cause the processor to:
receive payment information from the consumer for paying for the offer; and
communicating the payment information to a computer system capable of processing payments.

29. The system of claim 26 wherein the processor readable instructions, when executed, further cause the processor to communicate, to the consumer computing device, a voucher for redeeming the offer at the venue location.

30. The system of claim 29 wherein the voucher comprises a voucher code.

31. The system of claim 29 wherein the voucher comprises a scanable image.

32. The system of claim 31 wherein the scanable images is a QR code or UPC code.

33. The system of claim 26 wherein the display unit is affixed to the exterior of a vehicle.

34. The system of claim 26 wherein the connection information comprises an indication of the name for the wireless access point.

35. The system of claim 26 wherein the connection information comprises login credentials associated with gaining access to the wireless access point.

36. A system for presenting an offer to a customer by comparing desired customer attributes of a venue with a plurality of existing for-hire vehicle passengers, the system comprising:
a processor;
a storage medium storing processor readable instructions that when executed cause the processor to:
access a plurality of customer attributes desired by a venue;
determine whether the venue needs to attract additional customers at an instant in time;
obtain, in real-time, passenger information from a plurality of for-hire vehicles, the information describing passenger attributes of current passengers of the plurality of for-hire vehicles at the instant in time;
compare the passenger information with the attributes desired by the venue;
generate an offer for a discounted venue event ticket that may be redeemed at the venue; and,
send the offer to some or all of the current passengers of the plurality of for-hire vehicles based at least in part on the comparison.

37. The system of claim 36, wherein plurality of customer attributes desired by a venue comprise those passengers within a distance range of the venue.

38. The system of claim 36, wherein plurality of customer attributes desired by a venue comprise a for-hire vehicle pick-up location.

39. The system of claim 36, wherein plurality of customer attributes desired by a venue comprise a for-hire vehicle drop-off location.

40. The system of claim 36, wherein the processor readable instructions when executed further cause the processor to:
receive a reply to the offer from at least one of the plurality of for-hire vehicles the reply comprising an indication that a replying passenger has accepted the offer.

41. The system of claim 40, wherein:
the reply to the offer further comprises payment information of the replying passenger for paying for the offer, and
the processor readable instructions when executed further cause the processor to send the payment information to a payment processor.
